(19) United States
(12) Patent Application Publication
(10) Pub. No.: US 2010/0000487 A1
(43) Pub. Date: Jan. 7, 2010

(54) ENGINE STARTING APPARATUS

(75) Inventors: Shogo Hoshino, Kariya-city (JP); Satoshi Miyazaki, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/496,743

(22) Filed: Jul. 2, 2009

(30) Foreign Application Priority Data
Jul. 2, 2008 (JP) 2008-173177
Feb. 12, 2009 (JP) 2009-030045

(51) Int. Cl. F02N 17/00; F02D 41/06

(52) U.S. Cl. 123/179.4; 701/113

(57) ABSTRACT

An ECU restarts a diesel engine without using a starter by injecting fuel into one of a plurality of cylinders, which is stopped in an expansion stroke, when an in-cylinder temperature of the one of the plurality of cylinders, which is stopped in the expansion stroker is equal to or higher than a preset temperature. Furthermore, the ECU restarts the diesel engine by using the starter when the in-cylinder temperature of the one of the plurality of cylinders, which is stopped in the expansion stroke, is lower than the preset temperature.

### CROSS REFERENCE TO RELATED APPLICATION

This application is based on and incorporates herein by reference Japanese Patent Application No. 2008-173177 filed on Jul. 2, 2008 and Japanese Patent Application No. 2009-030045 filed on Feb. 12, 2009.

### BACKGROUND OF THE INVENTION

1. Field of the Invention

The present invention relates to an engine starting apparatus for a diesel engine.

2. Description of Related Art

According to a previously known technique, an engine is automatically stopped to reduce the fuel consumption and the exhaust gas when a vehicle is stopped at a traffic light or traffic jam. Japanese Unexamined Patent Publication No. 2002-39038A teaches an engine starting apparatus, which restarts an engine without using a starter by injecting fuel into a cylinder, which is stopped in an expansion stroke, and then igniting the fuel with a spark plug after the automatic stop of the engine. When the engine is restarted without using the starter, it is possible to limit an increase in the number of uses of the starter and the operating time period of the starter. Therefore, the reduction in the lifetime of the starter and the lifetime of peripheral components thereof can be limited, and the electric power consumption of the starter can be reduced.

The prior art engine starting apparatus is designed for a gasoline engine, as discussed in Japanese Unexamined Patent Publication No. 2002-39038A. Unlike the gasoline engine, the diesel engine does not have the spark plug. Therefore, when the fuel, which is injected into the cylinder, needs to be self-ignited, it is required to satisfy a self-ignitable condition of the fuel in view of the in-cylinder temperature and the in-cylinder pressure. Therefore, when the prior art engine starting apparatus is applied to the diesel engine, the fuel, which is injected into the cylinder, does not self-ignite depending on the state in the cylinder, which is stopped in the expansion stroke, thereby possibly resulting in a failure in the restart of the engine using no starter.

### SUMMARY OF THE INVENTION

The present invention addresses the above disadvantages.

According to the present invention, there is provided an engine starting apparatus for a diesel engine, which includes a fuel injection means, a starter, an S automatic stop control means and a restarting means. The fuel injection means is for injecting fuel from a plurality of fuel injection valves, which are respectively provided to a plurality of cylinders of the diesel engine, into the plurality of cylinders, respectively. The starter is adapted to start the diesel engine by rotating a crankshaft of the diesel engine. The automatic stop control means is for automatically stopping the diesel engine when an engine stop condition, which is a condition required for engine stop, is satisfied. The restarting means is for restarting the diesel engine upon satisfaction of a restart condition, which is a condition required for engine start, after stopping of the diesel engine caused by satisfaction of at least the engine stop condition as follows. That is, the restarting means restarts the diesel engine without using the starter by injecting fuel into one of the plurality of cylinders, which is stopped in an expansion stroke, through the fuel injection means when an in-cylinder temperature of the one of the plurality of cylinders, which is stopped in the expansion stroke, is equal to or higher than a preset temperature. Also, the restarting means restarts the diesel engine by using the starter when the in-cylinder temperature of the one of the plurality of cylinders, which is stopped in the expansion stroke, is lower than the preset temperature.

The restarting means described above may be modified as follows. That is, the restarting means may restart the diesel engine without using the starter by injecting fuel into one of the plurality of cylinders, which is stopped in an expansion stroke, through the fuel injection means when a relationship between an in-cylinder temperature and an in-cylinder pressure of the one of the plurality of cylinders, which is stopped in the expansion stroke, satisfies a preset condition. Also, the restarting means may restart the diesel engine by using the starter when the relationship between the in-cylinder temperature and the in-cylinder pressure of the one of the plurality of cylinders, which is stopped in the expansion stroke, does not satisfy the preset condition.

Also, the restarting means described above may be modified as follows. That is, the restarting means may restart the diesel engine without using the starter by injecting fuel into one of the plurality of cylinders, which is stopped in an expansion stroke, through the fuel injection means when an in-cylinder temperature of the one of the plurality of cylinders, which is stopped in the expansion stroker is equal to or higher than a first preset temperature. Also, the restarting means may restart the diesel engine by using the starter and also by injecting fuel into the one of the plurality of cylinders, which is stopped in the expansion stroke, through the fuel injection means when the in-cylinder temperature of the one of the plurality of cylinders, which is stopped in the expansion stroke, is lower than the first preset temperature and is equal to or higher than a second preset temperature that is lower than the first preset temperature. Furthermore, the restarting means may restart the diesel engine by using the starter when the in-cylinder temperature of the one of the plurality of cylinders, which is stopped in the expansion stroke, is lower than the second preset temperature.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing an engine system, in which an engine starting apparatus according to a first embodiment of the present invention is applied;

FIG. 2 is a flowchart showing a main operation of the engine starting apparatus according to the first embodiment;

FIG. 3 is a flowchart showing a subroutine of the main operation shown in FIG. 2, indicating an engine stop determining operation;

FIG. 4 is a flowchart showing a subroutine of the main operation shown in FIG. 2, indicating an engine restart determining operation;

FIG. 5 is a flowchart showing a subroutine of the engine restart determining operation shown in FIG. 4, indicating an automatic start determining operation;

FIG. 6 is a flowchart showing a subroutine of the engine restart determining operation shown in FIG. 4, indicating an automatic transmission vehicle manipulation start determining operation;

FIG. 7 is a flowchart showing a subroutine of the engine restart determining operation shown in FIG. 4, indicating a manual transmission vehicle manipulation start determining operation;

FIG. 8 is a diagram showing various strokes of respective cylinders of the engine, to which the engine system having the engine starting apparatus of the first embodiment is applied;

FIG. 9A is a diagram showing a cylinder of the engine, which is in an expansion stroke according to the first embodiment;

FIG. 9B is a diagram showing a cylinder of the engine, which is in a compression stroke according to the first embodiment;

FIG. 10 is a diagram showing a relationship of each injection pattern determined by the engine starting apparatus relative to an in-cylinder temperature and an injection quantity of the fuel according to the first embodiment;

FIG. 11A is a diagram showing the cylinder of the engine, which is stopped in the expansion stroke according to the first embodiment;

FIG. 11B is a diagram showing the cylinder of the engine, which is stopped in the compression stroke according to the first embodiment;

FIG. 12 is a flowchart showing a main operation of the engine starting apparatus according to a second embodiment of the present invention;

FIG. 13 is a diagram showing a relationship between an in-cylinder temperature and an in-cylinder pressure according to the second embodiment;

FIG. 14 is a flowchart showing a main operation of the engine starting apparatus according to a third embodiment of the present invention; and

FIG. 15 is a diagram showing a way of selecting an engine restarting means at the engine starting apparatus based on the in-cylinder temperature according to the third embodiment.

### DETAILED DESCRIPTION OF THE INVENTION

Embodiments of the present invention will be described with reference to the accompanying drawings.

### First Embodiment

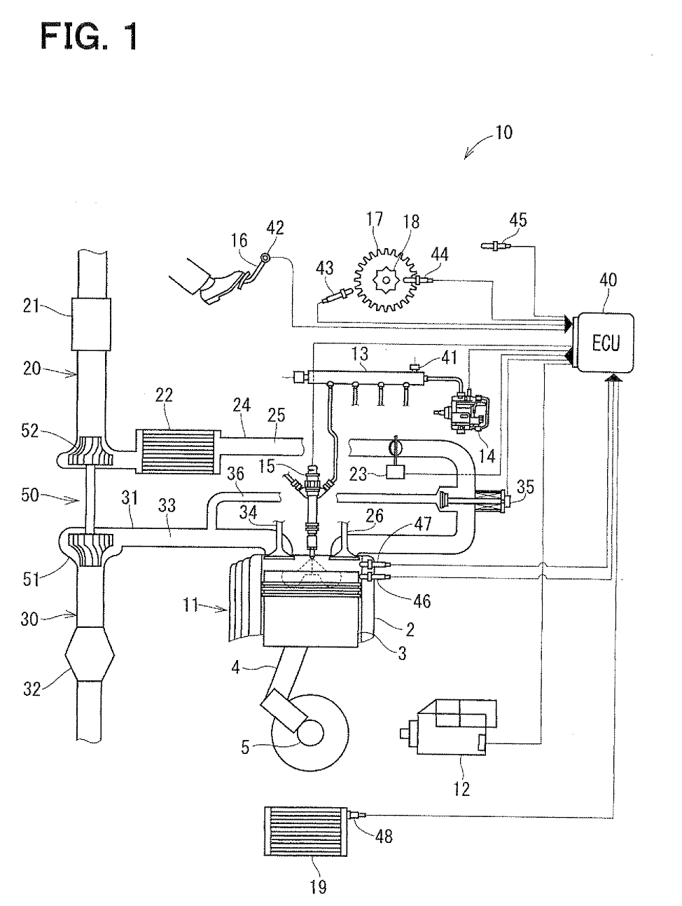

An engine system, in which an engine starting apparatus according to a first embodiment of the present invention is applied, will be described with reference to FIG. 1. A four cylinder diesel engine installed in a vehicle serves as a control subject of the engine starting apparatus. The engine system 10 includes the engine 11, a starter 12, a common rail 13, a supply pump 14, an injector 15 and an electric control unit (ECU) 40.

The engine 11, which is the diesel engine, has four cylinders 2. Each cylinder 2 receives a piston 3. The piston 3 is connected to a crank shaft 5 through a connecting rod 4. In this way, the reciprocal movement of the piston 3 in the cylinder 2 is conducted to the crankshaft 5 and is converted into the corresponding rotational movement. The starter 12 is connectable to the crankshaft 5. The starter 12 is connected to the crankshaft 5 to start the engine 11 by rotating the crankshaft 5. For example, the starter 12 is used when the engine 11 needs to be started (for example, at the time of starting the operation of the vehicle) regardless of combustion of fuel.

The supply pump 14 receives fuel accumulated in a fuel tank (not shown). Then, the supply pump 14 compresses and discharges the received fuel. The common rail 13 accumulates the pressurized fuel, which is pressurized in and is supplied from the supply pump 14, in such a manner that the common rail 13 maintains the pressure of the supplied fuel, that is the common rail 13 accumulates the fuel in the pressurized state. The common rail 13 is connected to each injector 15, which is provided to the corresponding cylinder 2 of the engine 11. In the case of the four cylinder engine 11 shown in FIG. 1, four injectors 15 are connected to the common rail 13.

The injector 15, which is a fuel injection valve, is provided to the corresponding cylinder 2 of the engine 11 and injects the fuel, which is accumulated in the common rail 13 in the pressurized state, into the cylinder 2. The injector 15 includes a needle (not shown) and an electromagnetic drive device (not shown). The needle is reciprocated to enable and disable injection of the fuel through a fuel injection hole (not shown) of the injector 15, and the electromagnetic drive device drives the needle. The electromagnetic drive device is electrically connected to the ECU 40. In this way, each injector 15 intermittently executes and stops the injection of the fuel based on the electric control signal, which is outputted from the ECU 40.

An air intake system 20 and an exhaust system 30 are connected to the engine 11. The air intake system 20 includes an air cleaner 21, an intercooler 22, an electric throttle 23 and an air intake pipe 24. The air intake pipe 24 forms an air intake passage 25. The air intake passage 25 interconnects the air cleaner 21, the intercooler 22 and the engine 11. The air, which is taken into the engine 11, is filtered through the air cleaner 21 to remove foreign objects. The air, which has passed through the air cleaner 21, is supplied to each cylinder 2 of the engine 11 through the electric throttle 23 and an air intake valve 26. The electric throttle 23 opens or closes the air intake passage 25. A flow quantity of the intake air, which is drawn into the engine 11, is adjusted by opening or closing the air intake passage 25 with the electric throttle 23.

The exhaust system 30 includes an exhaust pipe 31 and a catalytic converter 32. The exhaust pipe 31 forms an exhaust passage 33. The exhaust pipe 31 guides the exhaust gas, which is discharged from the engine 11 through an exhaust valve 34, to the outside. The catalytic converter 32 is placed in the exhaust pipe 31. The catalytic converter 32 has a catalyst to deoxidize or oxidize, for example, hydrocarbons and/or nitrogen oxides contained in the exhaust gas to render them harmless.

A supercharger 50 is placed between the air intake system 20 and the exhaust system 30. The supercharger 50 includes a turbine 51 and a compressor 52. The turbine 51 is rotated by the exhaust gas, which flows in the exhaust passage 33, and the compressor 52 is rotated through the rotation of the turbine 51 to compress the intake air, which flows in the air intake passage 25. The intake air, which is compressed by the compressor 52 and is heated to the high temperature by the compressor 52, is cooled by the intercooler 22. An exhaust gas recirculation device 35 is provided in the engine system 10. The exhaust gas recirculation device 35 recirculates a portion of the exhaust gas into the air intake system 20 through the passage 36.

The ECU 40, which serves as the engine starting apparatus, has a microcomputer that includes a CPU, a ROM and a RAM (not shown). Furthermore, the ECU 40 controls the engine system 10 and the vehicle having the engine system 10 according to the programs stored in the ROM. The ECU 40 is connected to the injector 15, the electric throttle 23, the supply pump 14, the exhaust gas recirculation device 35 and the starter 12. Furthermore, a common rail pressure sensor 41, an accelerator pedal position sensor 42, a crank angle sensor 43, a cylinder identifying sensor 44, a vehicle speed sensor 45, an in-cylinder temperature sensor 46, an in-cylinder pressure sensor 47 and a coolant temperature sensor 48 are connected to the ECU 40. The ECU 40 functions as a fuel injection means, an automatic stop control means, restarting means, a piston stopping means, a stop aiding means and a compression pressure reducing means of the present invention.

The common rail pressure sensor 41 is provided to the common rail 13 and senses the pressure of the fuel accumulated in the common rail 13, i.e., senses the common rail pressure. The common rail pressure sensor 41 outputs the sensed common rail pressure to the ECU 40 as an electric signal.

The accelerator pedal position sensor 42 is provided to the accelerator pedal 16 and senses a degree of depression of the accelerator pedal 16, i.e., senses a degree of opening of the accelerator. The accelerator pedal position sensor 42 outputs the degree of depression of the accelerator pedal 16, i.e., the degree of opening of the accelerator to the ECU 40 as an electric signal.

The crank angle sensor 43 is provided at a location radially outward of an NE pulsar 17 that is rotated together with the crankshaft 5 of the engine 11. The crank angle sensor 43 outputs the angle of the crankshaft 5, i.e., an electric signal, which corresponds to the crank angle, to the ECU 40. The cylinder identifying sensor 44 is provided at a location radially outward of a G pulsar 18, which is rotated together with a camshaft (not shown). The NE pulsar 17 makes two rotations per rotation of the G pulsar 18. Teeth are arranged one after another along an outer peripheral part of the NE pulsar 17. The number of teeth of the NE pulsar 17, which is sensed with the crank angle sensor 43 per unit time, is used to compute the rotational speed of the crankshaft 5, i.e., the rotational speed of the engine 11. The crank angle sensor 43 outputs the sensed rotational speed of the engine 11 to the ECU 40 as an electric signal. The ECU 40 computes the rotational speed of the engine 11 based on the rotational speed outputted from the crank angle sensor 43. Teeth are arranged one after another along an outer peripheral part of the G pulsar 18 to identify the respective cylinders (first to fourth cylinders). The cylinder identifying sensor 44 outputs the electric signal, which corresponds to the indentified cylinder, to the ECU 40. The ECU 40 can estimate the current stroke of each cylinder based on the signals from the cylinder identifying sensor 44 and the crank angle sensor 43.

The vehicle speed sensor 45 is provided to a location radially outward of a shaft connected to, for example, a wheel of the vehicle and outputs the rotational speed of the wheel to the ECU 40 as an electric signal. The ECU 40 computes the vehicle speed based on the rotational speed, which is outputted from the vehicle speed sensor 45.

The in-cylinder temperature sensor 46 is provided to each cylinder 2 and senses the in-cylinder temperature (the temperature in the cylinder). The in-cylinder temperature sensor 46 outputs the sensed in-cylinder temperature to the ECU 40 as an electric signal.

Similar to the in-cylinder temperature sensor 46, the in-cylinder pressure sensor 47 is provided to each cylinder 2 and senses the in-cylinder pressure of the cylinder 2 (the pressure in the cylinder 2). The in-cylinder pressure sensor 47 outputs the sensed in-cylinder pressure to the ECU 40 as an electric signal.

The coolant temperature sensor 48 is provided to a radiator 19 and senses the temperature of the coolant, which cools the engine 11. The coolant temperature sensor 48 outputs the sensed coolant temperature to the ECU 40 as an electric signal.

The ECU 40 adjusts the degree of opening of the electric throttle 23 according to the degree of depression of the accelerator pedal 16, which is sensed with the accelerator pedal position sensor 42. Furthermore, the ECU 40 estimates a load of the engine 11 based on the output of the accelerator pedal position sensor 42, the output of the crank angle sensor 43 and the output of the coolant temperature sensor 48. The ECU 40 computes the fuel quantity to be supplied to the engine 11 based on the estimated load of the engine 11. The ECU 40 senses the common rail pressure at preset intervals with the common rail pressure sensor 41 and adjusts the flow quantity of fuel to be supplied from the fuel tank to the supply pump 14 in such a manner that the common rail pressure coincides with a preset pressure based on the computed fuel quantity. Also, the ECU 40 adjusts a valve open time period of the injector 15 to supply the preset quantity of fuel to the engine 11.

In the engine system 10, the engine 11 has the four cylinders 2 (#1-4). Furthermore, each cylinder 2 is provided with the corresponding one of the injectors 15. The injector 15 injects the fuel into the cylinder 2 according to an electric control signal received from the ECU 40. That is, when the electromagnetic drive device of the injector 15 receives the control signal, which indicates the fuel injection from the ECU 40, the electromagnetic drive device of the injector 15 drives the needle. In this way, the needle is moved away from the injection hole of the injector 15 to open the injection hole. Therefore, the fuel is injected from the injection hole of the injector 15. As discussed above, the ECU 40 functions as the fuel injection means and executes the injection of the fuel into each cylinder 2 of the engine 11.

As discussed above, the ECU 40 estimates the load of the engine 11 based on the measurement signal of each corresponding sensor and generates the injection pulse as the control signal to implement the most appropriate target injection quantity and the target injection timing based on the estimated load of the engine 11. Here, a relationship between the pulse width and pulse rise timing for generating the injection pulse and the operational state of the engine 11 is previously prepared and is stored in the RAM as a map. At the time of normal operation, the ECU 40 controls each injector 15 based on the map to inject the corresponding quantity of fuel, which corresponds to the load of the engine 11.

Next, the restarting operation of the engine 11 executed by the ECU 40 will be described.

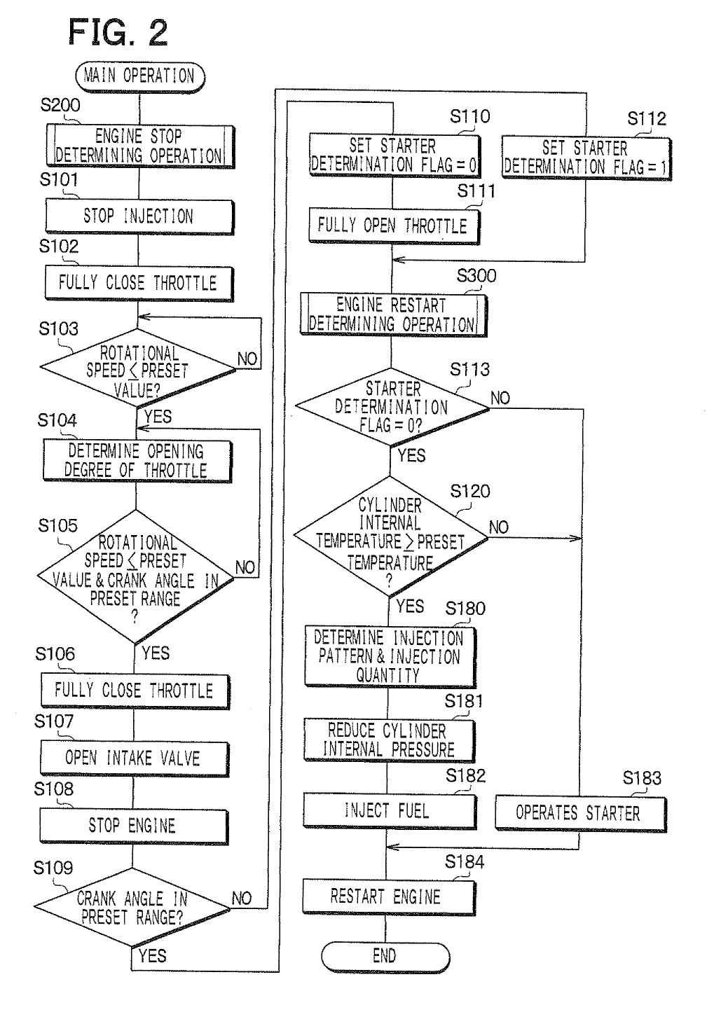

In the present embodiment, the ECU 40 functions as the automatic stopping means in the main operation. Thereby, the ECU 40 automatically stops the engine 11 when the ECU 40 determines that the engine 11 can be stopped, for example, at the time when it is obvious that the vehicle is stopped at the red traffic signal. Furthermore, the ECU 40 functions as the restarting means. Thereby, the ECU 40 restarts the engine 11 when the engine 11 needs to be restarted, for example, at the time of sensing the manipulation of the accelerator pedal by the driver or at the time of increasing the electric power consumption of the devices installed in the vehicle. More specifically, in such a case where the engine 11 needs to be restarted, the ECU 40 restarts the engine 11 without using the starter when the current in-cylinder temperature of the corresponding one of the cylinders 2, which is in the expansion stroke at the time of stopping the engine 11, is equal to or higher than the preset temperature. In contrast, when the in-cylinder temperature of the corresponding one of the cylinders, which is in the expansion stroke at the time of stopping the engine 11, is lower than the preset temperature, the ECU 40 uses the starter 12 to restart the engine 11. The above described operation will be discussed with reference to FIGS. 2 to 7.

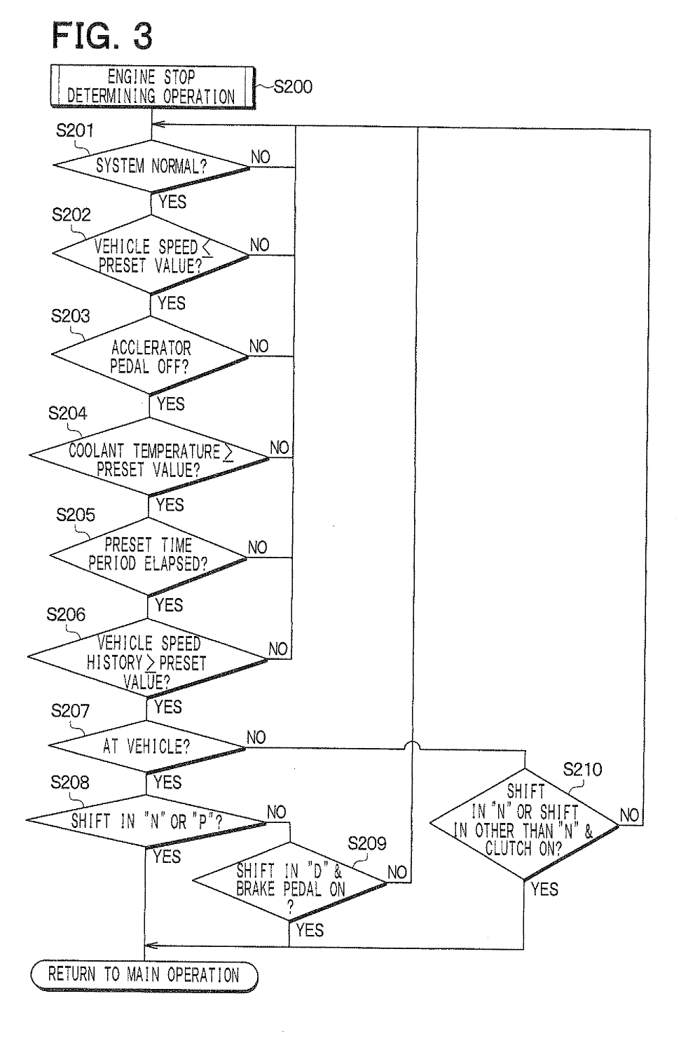

The flow of FIG. 2 shows the main operation, and the flow of FIGS. 3 to 7 shows the subroutine operations of the main operation. The main operation shown in FIG. 2 is started at the time of starting the operation of the vehicle, i.e., at the time of turning on of the ignition key of the vehicle. The main operation of the ECU 40 is stopped when the engine is restarted upon execution of the main operation. Thereafter, the ECU 40 starts the main operation from the start of the main operation after the end of the previous main operation Here, it should be noted that the ECU 40 stops the execution of the main operation or the subroutine operation when the ignition key is turned off in the middle of the main operation of the subroutine operation.

As shown in FIG. 2, when the main operation is started, the ECU 40 executes the engine stop determining operation at step S200.

The engine stop determining operation at step S200 of FIG. 3 is the operation, which is executed when it is determined that the engine 11 can be stopped in, for example, the case where it is obvious that the vehicle is stopped, i.e., when an engine stop condition for stopping the engine 11 is satisfied. When it is determined that the engine stop condition is satisfied upon the execution of the engine stop determining operation at step S200 shown in FIG. 3, the operation returns to the main operation.

When the engine stop determining operation of step 200 is started, the operation proceeds to step S201.

At step 201, the ECU 40 determines whether the system is normal. When it is determined that the system is normal at step S201 (i.e., YES at step S201), the operation proceeds to step S202. In contrast, when it is determined that the system is not normal, i.e., is abnormal at step S201 (i.e., NO at step S201), the operation returns to step S201. That is, the determination at step 201 is repeated until the ECU 40 determines that the system is normal at step 201.

Then, at step S202, the vehicle speed is computed based on the signal received from the vehicle speed sensor 45, and it is determined whether the computed vehicle speed is equal to or lower than the preset value. When it is determined that the vehicle speed is equal to or lower than the preset value at step S202 (i.e., YES at step S202), the operation proceeds to step S203. In contrast, when it is determined that the vehicle speed is higher than the preset value at step S202 (i.e., NO at step S202), the operation returns to step S201.

At step S203, the ECU 40 determines whether the degree of depression of the accelerator pedal 16 (the degree of opening of the accelerator) is zero, i.e., whether the accelerator pedal 16 is not depressed (OFF) by the driver based on the signal from the accelerator pedal position sensor 42. When the ECU 40 determines that the accelerator pedal 16 is not depressed at step S203 (i.e., YES at step S203), the operation proceeds to step S204. In contrast, when the ECU 40 determines that the accelerator pedal 16 is depressed at step S203 (i.e., NO at step S203), the operation returns to step S201.

At step S204, the ECU 40 determines whether the coolant temperature is equal to or higher than a preset value. When it is determined that the coolant temperature is equal to or higher than the preset value at step S204 (i.e., YES at step S204), the operation proceeds to step S205. In contrast, when it is determined that the coolant temperature is lower than the preset value at step S204 (i.e., NO at step S204), the operation returns to step S201.

At step S205, the ECU 40 determines whether a preset time period has elapsed since the time of starting the engine 11 (the time of previous engine start) based on, for example, a value of a counter. When it is determined that the preset time period has elapsed since the time of starting the engine 11 at step S205 (i.e., YES at step S205), the operation proceeds to step S206. When it is determined that the preset time period has not elapsed since the time of starting the engine 11 at step S205 (i.e., NO at step S205), the operation returns to step S201.

At step S206, the ECU 40 determines whether a vehicle speed history indicates that the vehicle speed has reached equal to or higher than the preset value after the previous engine start. The ECU 40 computes the vehicle speed based on the signal from the vehicle speed sensor 45 and stores the vehicle speed history of the computed vehicle speed(s) in the RAM. When the ECU 40 determines that the vehicle speed history indicates that the vehicle speed has reached equal to or higher than the preset value after the previous engine start at step S206 (i.e., YES at step S206), the operation proceeds to step S207 When the ECU 40 determines that the vehicle speed history does not indicate that the vehicle speed has reached equal to or higher than the preset value after the previous engine start at step S206 (i.e., NO at step S206), the operation returns to step S201.

At step S207 the ECU 40 determines whether the vehicle is an automatic transmission (AT) vehicle. When it is determined that the vehicle is the automatic transmission vehicle at step S207 (i.e., YES at step S207), the operation proceeds to step S208. In contrast, when it is determined that the vehicle is not the automatic transmission vehicle, i.e., when it is determined that the vehicle is a manual transmission (MT) vehicle at step S207 (i.e., NO at step S207), the operation proceeds to step S210.

At step S208, the ECU 40 determines whether a shift position of the automatic transmission is a neutral (N) or parking (P) position. When it is determined that the shift position of the automatic transmission is the N or P position at step S208 (i.e., YES at step S208), the ECU 40 determines that the engine stop condition is satisfied, so that the ECU 40 terminates the engine stop determining operation of step S200 and returns to the main operation. In contrast, when it is determined that the shift position of the automatic transmission is not N or P position at step S208 (i.e., NO at step S208), the operation proceeds to step S209.

At step S209, the ECU 40 determines whether the shift position is a drive (D) position in a state where the brake pedal is depressed. When the ECU 40 determines that the shift position of the automatic transmission is the D position in the state where the brake pedal is depressed at step S209 (i.e., YES at step S209), the ECU 40 determined that the engine stop condition is satisfied. Therefore, the ECU 40 terminates the engine stop determining operation (step S200) and returns to the main operation. In contrast, when the ECU 40 determines that the shift position is not the D position or the brake pedal is not depressed at step S209 (i.e., NO at step S209), the operation returns to step S201.

At step S210, the ECU 40 determines whether a shift position of the manual transmission is a neutral (N) position or is any other position other than the N position in a depressed state of a clutch pedal. When the ECU 40 determines that the shift position of the manual transmission is the N position or is any other position other than the N position in the depressed state of the clutch pedal at step S210 (i.e., YES at step S210), the ECU 40 determines that the engine stop condition is satisfied. Therefore, the ECU 40 terminates the engine stop determining operation (step S200) and returns to the main operation. In contrast, when the ECU 40 determines that the shift position of the manual transmission is the other position, which is other than the N position, in an undepressed state of the clutch pedal at step S210 (i.e., NO at step S210), the operation returns to step S201.

As shown in FIG. 2, when it is determined that the engine stop condition is satisfied upon the termination of the engine stop determining operation (S200), the operation proceeds to step S101.

At step S101, the ECU 40 stops the outputting of the injection control signal to the respective injectors 15. In this way, the injection of the fuel from each injector 15 into the corresponding cylinder 2 is stopped. Therefore, the rotational speed of the engine 11 is gradually reduced. After the execution of step S101, the operation proceeds to step S102.

At step S102, the ECU 40 adjusts the opening degree of the electric throttle 23 to zero. In this way, the inflow of the air into the respective cylinders 2 through the air intake passage 25 is stopped. As a result, the vibration of the engine 11, which could be generated by the inflow of the fresh air, is reduced. Thereafter, the operation proceeds to step S103.

At step S103, the ECU 40 determines whether the rotational speed of the engine 11 is equal to or lower than a preset value. When it is determined that the rotational speed of the engine 11 is equal to or lower than the preset value at step S103 (i.e., YES at step S103), the operation proceeds to step S104. In contrast,.when it is determined that the rotational speed of the engine 11 is higher than the preset value at step S103 (i.e., NO at step S103), the operation returns to step S103. That is, in such a case, the determination at step S103 is repeated.

At step S104, a target degree of opening (target opening degree) of the electric throttle 23 is determined based on the rotational speed of the engine 11, and the degree of opening of the electric throttle 23 is adjusted to coincide with the determined target degree of opening of the electric throttle 23. At this time, when the rotational speed of the engine 11 is increased, the target degree of opening of the electric throttle 23 is reduced. In contrast when the rotational speed of the engine 11 is reduced, the target degree of opening of the electric throttle 23 is increased. That is, when the rotation of the engine 11 is reduced toward the stop state, the target degree of opening of the electric throttle 23 is increased. When the degree of opening of the electric throttle 23 is adjusted in this manner, the engine 11 can be easily stopped at a desired crank angle. After the execution of step S104, the operation proceeds to step S105.

At step S105, the ECU 40 determines whether the rotational speed of the engine 11 is equal to or lower the preset value while the crank angle is within the preset angular range. When it is determined that the rotational speed of the engine 11 is equal to or lower than the preset value while the crank angle is within the preset angular range at step S105 (i.e., YES at step S105), the operation proceeds to step S106. In contrast, when it is determined that the rotational speed of the engine 11 is higher than the preset value while the crank angle is not within the preset angular range at step S105 (i.e., NO at step S105), the operation returns to step S104.

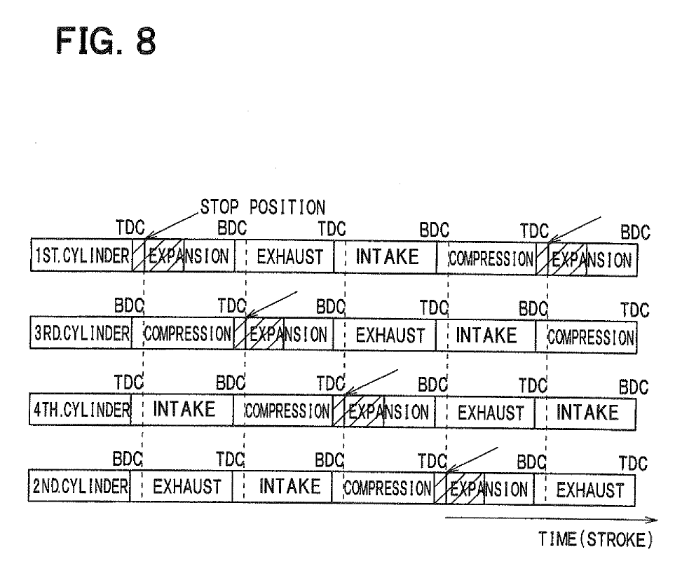

The preset angular range of the crank angle discussed with respect to step S105 will be described in detail. As shown in FIG. 8, each of the cylinders (#1-4) repeats the expansion stroke, the exhaust stroke, the intake stroke and the compression stroke with time. The preset angular range of the crank angle is an angular range of the crank angle from the top dead center (TDC) to an intermediate position between the top dead center to the bottom dead center (BDC) and is shown with a shade in FIG. 8. That is, the preset angular range is the range of 0 to 90 degrees right after the top dead center of the cylinder 2, which is in the expansion stroke. The expansion stroke of the third cylinder starts after completion of the expansion stroke of the first cylinder. Then, the expansion stroke of the fourth cylinder starts after completion of the expansion stroke of the third cylinder. As discussed above, when the expansion stroke of one of the cylinders is completed, the expansion stroke of another one of the cylinders is started. Therefore, the preset angular range includes the multiple ranges.

At step S106, the ECU 40 adjusts the opening degree of the electric throttle 23 to zero. Thereafter, the operation proceeds to step S107.

At step S107, the ECU 40 opens the intake valve 26 of the cylinder 2, which is in the compression stroke. In this way, the boost pressure is introduced into the cylinder 2, which is in the compression stroke, so that the in-cylinder pressure of this cylinder 2 is increased.

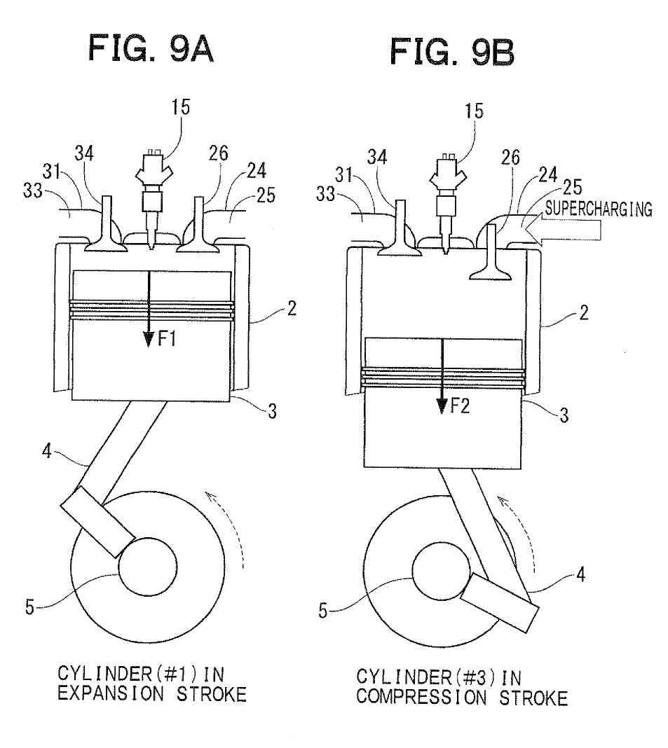

FIG. 9A shows the cylinder, which is in the expansion stroke at this moment, and FIG. 9B shows the cylinder, which is in the compression stroke at this moment. For example, when the first cylinder (cylinder #1) is in the expansion stroke, the third cylinder (cylinder #3) is in the compression stroke. In the first cylinder, which is shown in FIG. 9A and is in the expansion stroke, although the fuel injection is kept stopped, the cylinder pressure is increased since the compression stroke has been already executed. This pressure acts on the top end surface of the piston 3 of the first cylinder to urge the piston 3 toward the bottom dead center. The piston 3 of the third cylinder, which is shown in FIG. 9B and is in the compression stroke, is moved toward the top dead center by the rotational force of the crankshaft 5, which is generated due to the movement of the piston 3 of the first cylinder toward the bottom dead center. At step S107, the intake valve 26 of the third cylinder, which is in the compression stroke, is opened, and thereby the boost pressure is introduced into the third cylinder. In this way, the in-cylinder pressure of the third cylinder is increased, and the pressure is applied on the top end surface of the piston 3 of the third cylinder. The piston 3, which moves toward the top dead center receives this pressure that acts as the force F2 for urging the piston 3 toward the bottom dead center. In this way, the force F1 is canceled by the force F2. Therefore, the movement of the piston 3 of the first cylinder toward the bottom dead center is limited, so that the piston 3 is stopped. Here, desirably, the piston 3 is stopped in the angular range of 10 to 30 degrees right after the top dead center of the first cylinder, which is in the expansion stroke. Because of the operation at step S107, the piston 3 can be easily stopped at the desired angle within the preset angular range right after the top dead center.

As shown in FIG. 2, the operation proceeds to step S108 after step S107.

At step S108, the ECU 40 confirms the stop of the engine 11 and stores the crank angle information. Thereafter, the operation proceeds to step S109.

At step S109, the ECU 40 determines whether the crank angle in this stop state of the engine 11 is within the preset angular range. Similar to the preset angular range discussed with respect to step S105, this preset angular range is, for example, the angular range of 0 to 90 degrees right after the top dead center of the cylinder 2, which is in the expansion stroke. When it is determined that the crank angle in the stopped state of the engine 11 is held within the preset angular range at step S109 (i.e., YES at step S109), the operation proceeds to step S110. When it is determined that the crank angle in the stop state of the engine 11 is held outside of the preset angular range at step S109 (i.e., NO at step S109), the operation proceeds to step S112.

At step S110, the ECU 40 stores 0 (zero) as a value of a starter determination flag in the RAM. Thereafter, the operation proceeds to step S111.

At step S111, the ECU 40 sets the opening degree of the electric throttle 23 to a maximum value thereof. Thereafter, the operation proceeds to step S300, at which an engine restart determining operation is executed.

At step S112, the ECU 40 stores 1 as the value of the starter determination flag in the RAM. Thereafter, the operation proceeds to step S300.

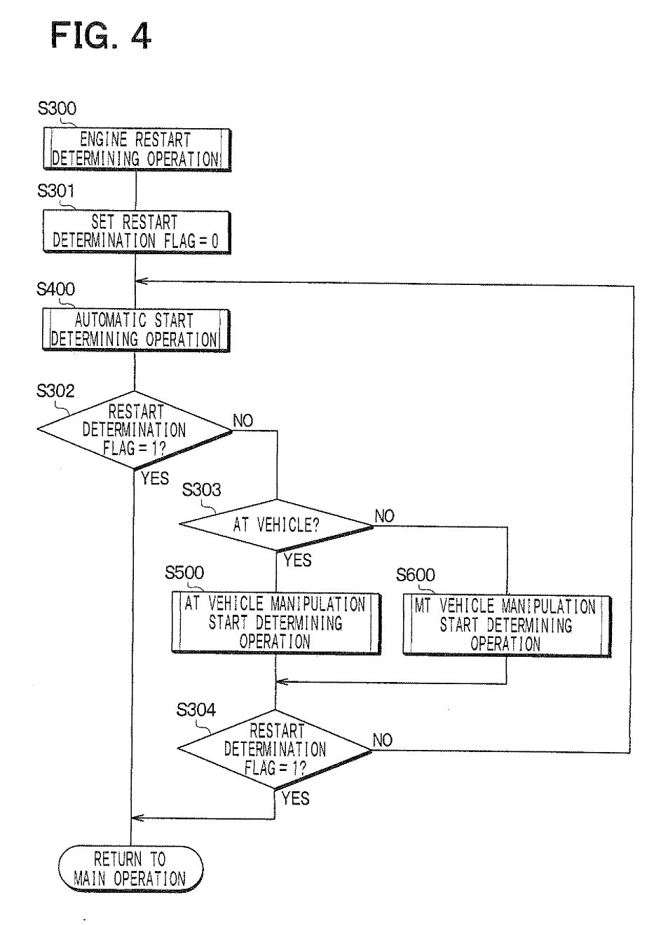

The operation at step S300 shown in FIG. 4 is an operation that determines whether a restart condition, which is a condition for starting the engine 11, is satisfied. This condition is satisfied, for example, when restart of the manipulation of the accelerator pedal is sensed or when the electric power consumption of the devices installed in the vehicle is increased. When the entire engine restart determining operation at step S300 is executed, it is determined that the restart condition is satisfied. Therefore, the operation returns to the main operation. When the engine restart determining operation of step 300 is started, the operation proceeds to step S301.

At step S301, the ECU 40 stores 0 (zero) as a value of a restart determination flag in the RAM. Thereafter, the operation proceeds to step S400, at which an automatic start determining operation is executed.

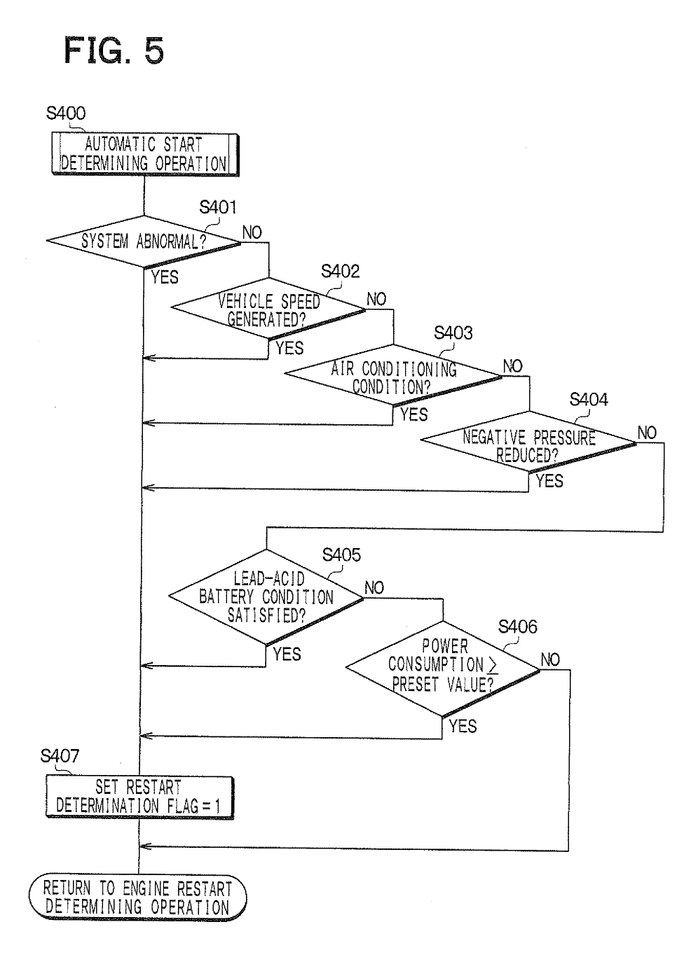

When the automatic start determining operation is started at step S400 shown in FIG. 5, the operation proceeds to step S401.

At step 401, the ECU 40 determines whether an abnormality exists in the system. When it is determined that the abnormality exists in the system at step S401 (i.e., YES at step S401), the operation proceeds to step S407. In contrast, when it is determined that the abnormality does not exist in the system, i.e., when it is determined that the system is normal at step S401 (i.e., NO at step S401), the operation proceeds to step S402.

Then, at step S402, the ECU 40 determines whether the vehicle is driven to generate the vehicle speed based on the signal from the vehicle speed sensor 45. When it is determined that the vehicle is driven to generate the vehicle speed at step S402 (i.e., YES at step S402), the operation proceeds to step S407. In contrast, when it is determined that the vehicle is not driven to generate the vehicle speed at step S402 (i.e., NO at step S402), the operation proceeds to step S403.

At step S403, the ECU 40 determines whether the air conditioning performance of the air conditioning system installed in the vehicle is reduced, i.e., whether an air conditioning condition is satisfied. When it is determined that the air conditioning condition is satisfied at step S403 (i.e., YES at step S403), the operation proceeds to step S407. In contrast, when it is determined that the air conditioning condition is not satisfied at step S403 (i.e., NO at step S403), the operation proceeds to step S404.

At step 404, the ECU 40 determines whether a negative pressure, which is supplied to a brake booster, is reduced. Normally, the rotational force of the engine 11 acts as a force that keeps the brake negative pressure to a preset pressure. Therefore, when the engine 11 is stopped, the negative pressure supplied to the brake booster may possibly be reduced. When it is determined that the negative pressure supplied to the brake booster is reduced at step S404 (i.e., YES at step S404), the operation proceeds to step S407. When it is determined that the negative pressure supplied to the brake booster is not reduced at step S404 (i.e., NO at step S404), the operation proceeds to step S405.

At step S405, the ECU 40 determines whether a voltage of a lead-acid battery, which supplies the electric power to the devices installed in the vehicle, is reduced, i.e., whether a lead-acid battery condition is satisfied. When it is determined that the lead-acid battery condition is satisfied at step S405 (i.e., YES at step S405), the operation proceeds to step S407. In contrast, when it is determined that the lead-acid battery condition is not satisfied at step S405 (i.e., NO at step S405), the operation proceeds to step S406.

At step S406, the ECU 40 determines whether the electric power consumption of the devices installed in the vehicle is equal to or higher than a preset value. When it is determined that the electric power consumption is equal to or higher than the preset value at step S406 (i.e., YES at step S406), the operation proceeds to step S407. In contrast, when it is determined that the electric power consumption is lower than the preset value at step S406 (i.e., NO at step S406), the value of the restart determination flag is kept as 0, and the automatic start determining operation at step S400 is terminated. Thereby, the ECU 40 returns to the engine restart determining operation.

At step S407, the ECU 40 stores 1 as the value of the restart determination flag in the RAM. Thereafter, the ECU 40 terminates the automatic start determining operation at step S400 and returns to the engine restart determining operation.

As shown in FIG. 4, the operation proceeds to step S302 after step S400.

At step S302, the ECU 40 determines whether the value of the restart determination flag stored in the RAM is 1. When it is determined that the value of the restart determination flag is 1 at step S302 (i.e., YES at step S302), the ECU 40 determines that the restart condition is satisfied. Therefore, the ECU 40 terminates the engine restart determining operation at step S300 and returns to the main operation. In contrast, when it is determined that the value of the restart determination flag is not 1, i.e., the value of the restart determination flag is 0 at step S302 (i.e., NO at step S302), the operation proceeds to step S303.

At step S303, the ECU 40 determines whether the vehicle is the automatic transmission vehicle. When it is determined that the vehicle is the automatic transmission vehicle at step S303 (i.e., YES at step S303), the operation proceeds to step S500, at which an automatic transmission vehicle manipulation start determining operation is executed. In contrast, when it is determined that the vehicle is not the automatic transmission vehicle, i.e., when it is determined that the vehicle is the manual transmission vehicle at step S303 (i.e., NO at step S303), the operation proceeds to step S600, at which a manual transmission vehicle manipulation start determining operation is executed.

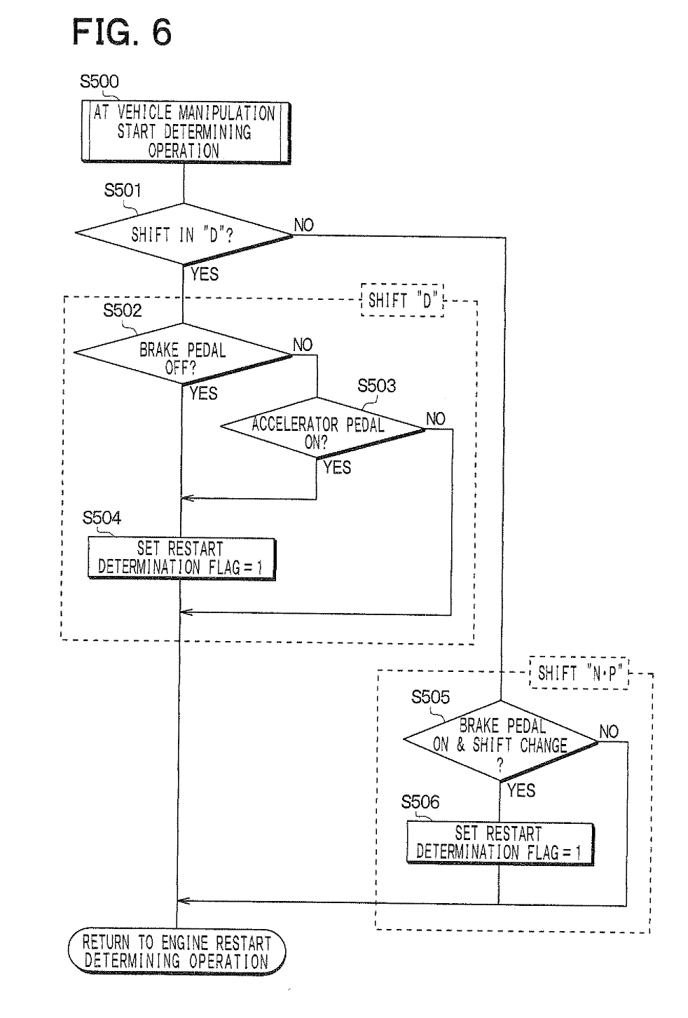

When the automatic transmission vehicle manipulation start determining operation at step S500 shown in FIG. 6 is started, the operation proceeds to step S501.

At step S501, the ECU 40 determines whether the shift position is in the D-position. When it is determined that shift position is in the D-position at step S501 (i.e., YES at step S501), the operation proceeds to step S502. In contrast, when the ECU 40 determines that the shift position is not in the D-position, i.e., the shift position is in the N-position or the P-position at step S501 (i.e., NO at step S501), the operation proceeds to step S505.

At step S502, the ECU 40 determines whether the brake pedal is not depressed (OFF state). When it is determined that the brake pedal is not depressed at step S502 (i.e., YES at step S502), the operation proceeds to step S504. In contrast, when it is determined that the brake pedal is depressed at step S502 (i.e., NO at step S502), the operation proceeds to step S503.

At step S503, the ECU 40 determines whether the accelerator pedal 16 is depressed. When the ECU 40 determines that the accelerator pedal 16 is depressed at step S503 (i.e., YES at step S503), the operation proceeds to step S504. In contrast, when the ECU 40 determines that the accelerator pedal 16 is not depressed at step S503 (i.e., NO at step S503), the value of the restart determination flag is maintained as 0, and the ECU 40 terminates the automatic transmission vehicle manipulation start determining operation at step S500. Thus, the ECU 40 returns to the engine restart determining operation.

At step S504, the ECU 40 stores 1 as the value of the restart determination flag in the RAM. Thereafter, the ECU 40 terminates the automatic transmission vehicle manipulation start determining operation at step S500 and returns to the engine restart determining operation.

At step S505, the ECU 40 determines whether the shift change manipulation is executed in the state where the brake pedal is depressed (i.e., in the ON state of the brake pedal). When the ECU 40 determines that the shift change manipulation is executed in the state where the brake pedal is depressed at step S505 (i.e., YES at step S505), the ECU 40 proceeds to step S506. In contrast, when the ECU 40 determines that the brake pedal is not depressed, and the shift change manipulation is not executed at step S505 (i.e., NO at step 5S05), the value of the restart determination flag is kept as 0, and the automatic transmission vehicle manipulation start determining operation at step S500 is terminated. Thereby, the ECU 40 returns to the engine restart determining operation.

At step S506, the ECU 40 stores 1 as the value of the restart determination flag in the RAM. Thereafter, the ECU 40 terminates the automatic transmission vehicle manipulation start determining operation at step S500 and returns to the engine restart determining operation.

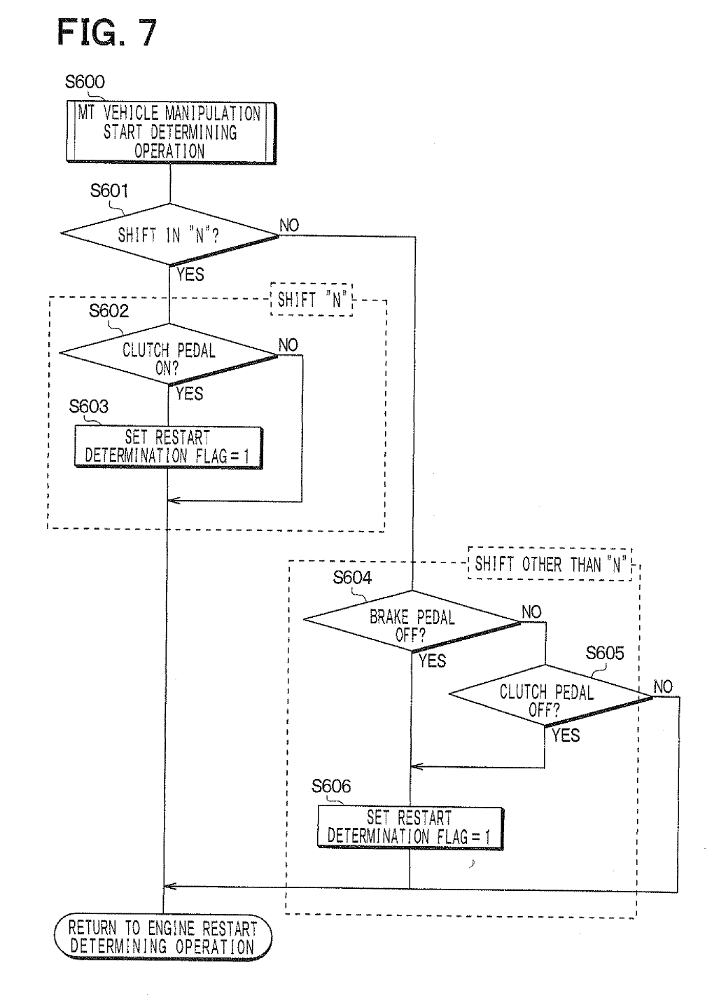

When the manual transmission vehicle manipulation start determining operation shown in FIG. 7 is started at step S600, the operation proceeds to step S601.

At step S601, the ECU 40 determines whether the shift position is in the N-position. When it is determined that shift position is in the N-position at step S601 (i.e., YES at step S601), the operation proceeds to step S602. In contrast, when it is determined that shift position is not in the N-position at step S601 (i.e., NO at step S601), the operation proceeds to step S604.

At step S602, the ECU 40 determines whether the clutch pedal is depressed (ON state). When it is determined that the clutch pedal is depressed at step S602 (i.e., YES at step S602), the operation proceeds to step S603. In contrast, when the ECU 40 determines that the clutch pedal is not depressed at step S602 (i.e., NO at step S602), the value of the restart determination flag is maintained as 0, and the ECU 40 terminates the manual transmission vehicle manipulation start determining operation at step S600. Thus, the ECU 40 returns to the engine restart determining operation.

At step S603, the ECU 40 stores 1 as the value of the restart determination flag in the RAM. Thereafter, the ECU 40 terminates the manual transmission vehicle manipulation start determining operation at step S600 and returns to the engine restart determining operation.

At step S604, the ECU 40 determines whether the brake pedal is not depressed (OFF state). When it is determined that the brake pedal is not depressed at step S604 (i.e., YES at step S604), the operation proceeds to step S606. In contrast, when it is determined that the brake pedal is depressed at step S604 (i.e., NO at step S604), the operation proceeds to step S605.

At step S605, the ECU 40 determines whether the clutch pedal is not depressed (OFF state). When it is determined that the clutch pedal is not depressed at step S605 (i.e., YES at step S605), the operation proceeds to step S606. In contrast, when the ECU 40 determines that the clutch pedal is depressed at step S605 (i.e., NO at step S605), the value of the restart determination flag is maintained as 0, and the ECU 40 terminates the manual transmission vehicle manipulation start determining operation at step S600. Thus, the ECU 40 returns to the engine restart determining operation.

At step S606, the ECU 40 stores 1 as the value of the restart determination flag in the RAM. Thereafter, the ECU 40 terminates the manual transmission vehicle manipulation start determining operation at step S600 and returns to the engine restart determining operation.

As shown in FIG. 4, the operation proceeds to step S304 after step S500 or step S600.

At step S304, the ECU 40 determines whether the value of the restart determination flag stored in the RAM is 1. When it is determined that the value of the restart determination flag is 1 at step S304 (i.e., YES at step S304), the ECU 40 determines that the restart condition is satisfied. Therefore, the ECU 40 terminates the engine restart determining operation at step S300 and returns to the main operation. In contrast, when it is determined that the value of the restart determination flag is not 1, i.e., the value of the restart determination flag is 0 at step S304 (i.e., NO at step S304), the operation returns to step S400.

As shown in FIG. 2, when it is determined that the restart condition is satisfied upon the execution of the operation at step S300, the operation proceeds to step S113.

At step S113, the ECU 40 determines whether the value of the starter determination flag stored in the RAM is 0. When it is determined that the value of the starter determination flag is 0 at step S113 (i.e., YES at step S113), the operation proceeds to step S120. In contrast, when it is determined that the value of the starter determination flag is not 0, i.e., the value of the starter determination flag is 1 at step S113 (i.e., NO at step S113), the operation proceeds to step S183.

At step S120, the ECU 40 determines whether the in-cylinder temperature of the cylinder 2, which is stopped in the expansion stroke, is equal to or higher than the preset temperature based on the crank angle information, which is stored in the stop period of the engine 11, and the measurement signal of the in-cylinder temperature sensor 46 provided to the cylinder 2. In this instance, the preset temperature is set to be the self-ignitable lower limit temperature of the fuel. When it is determined that the in-cylinder temperature of the cylinder 2, which is stopped in the expansion stroke, is equal to or higher than the preset temperature at step S120 (i.e., YES at step S120), the operation proceeds to step S180. When it is determined that the in-cylinder temperature of the cylinder 2, which is stopped in the expansion stroke, is lower than the preset temperature at step S120 (i.e., NO at step S120), the operation proceeds to step S183.

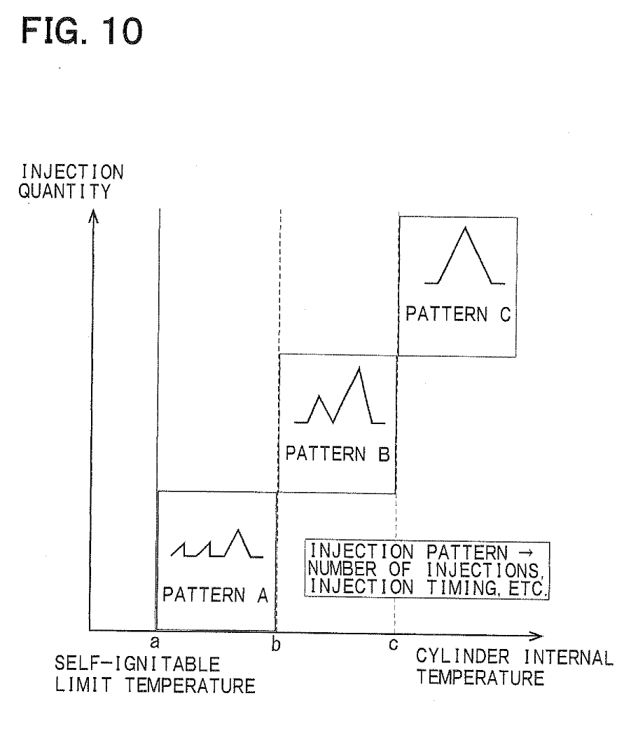

At step S180, the ECU 40 determines the injection pattern and the injection quantity of the fuel, which is injected into the cylinder 2 stopped in the expansion stroke, based on the in-cylinder temperature of this cylinder 2, which is stopped in the expansion stroke. The injection pattern and the injection quantity are determined based on the corresponding in-cylinder temperature range shown in FIG. 10.

The in-cylinder temperature “a” shown in FIG. 10 is the self-ignitable lower limit temperature of the fuel in the cylinder. The in-cylinder temperature “b” is higher than the in-cylinder temperature “a” by a preset amount. The in-cylinder temperature “c” is higher than the in-cylinder temperature “b” by a preset amount. At step S180, a pattern A is determined as the injection pattern in the case where the in-cylinder temperature of the cylinder 2, which is stopped in the expansion stroke, is equal to or higher than the temperature “a” and is lower than the temperature “b”. Furthermore, a pattern B is determined as the injection pattern in the case where the in-cylinder temperature of the cylinder 2, which is stopped in the expansion stroke, is equal to or higher than the temperature “b” and is lower than the temperature “c”. Furthermore, a pattern C is determined as the injection pattern in the case where the in-cylinder temperature of the cylinder 2, which is stopped in the expansion stroke, is equal to or higher than the temperature “c”. In FIG. 10, a waveform at the pattern A, a waveform at the pattern B and a waveform at the pattern C indicate the injection pulses, which are outputted at the pattern A, the pattern B and the pattern C, respectively. When the corresponding one of the injection pulses indicated at the patterns A, B, C is outputted to the injector 15, the injector 15 injects the fuel at the corresponding injection quantity, which corresponds to the area of the injection pulse.

In the present embodiment, when the injection pulse, which is indicated at the pattern A, is outputted to the injector 15, two fuel injections at the injection quantity smaller than the injection quantity of the main injection are executed before the execution of the main injection. When the fuel injection is divided into multiple fuel injections in the cylinder, the injected fuel can be easily self-ignited, and the appropriate combustion state of the fuel can be developed in the cylinder. When the injection pulse, which is indicated at the pattern B, is outputted to the injector 15, one fuel injection at the injection quantity smaller than the injection quantity of the main injection is executed before the execution of the main injection. Furthermore, when the injection pulse, which is indicated at the pattern C, is outputted to the injector 15, no fuel injection is executed before the execution of the main injection.

The fuel, which is injected into the cylinder, can be combusted in the greater quantity when the in-cylinder temperature is increased. The injection pulses at the patterns A to C are set as follows. That is, the total injection quantity of the fuel in the case of the injection pulse at the pattern B is larger than the total injection quantity of the fuel in the case of the injection pulse at the pattern A, and the total injection quantity of the fuel in the case of the injection pulse at the pattern C is larger than the total injection quantity of the fuel in the case of the injection pulse at the pattern B.

As shown in FIG. 2, the operation proceeds to step S181 after step S180.

At step S181, the ECU 40 opens the exhaust valve 34 of the cylinder 2, which is stopped in the compression stroke. In this way, the compressed air is discharged from the cylinder 2, which is stopped in the compression stroke, into the exhaust passage 33. Therefore, the in-cylinder pressure of the cylinder 2, i.e., the compression pressure of the cylinder 2 is reduced. After the execution of step S181, the operation proceeds to step S182.

At step S182, the ECU 40 commands the corresponding injector 15 to inject the fuel into the cylinder 2, which is stopped in the expansion stroke. At this time, the injection pattern of the injection pulse, which is outputted from the ECU 40 to the injector 15, is determined at step S180. In the present embodiment, the fuel, which is injected at step S182, is fuel having high ignitability (hereinafter, referred to as “highly ignitable fuel”), which is higher than that of the normally injected fuel. The highly ignitable fuel is stored in, for example, a separate tank that is different from the fuel tank, which stores the fuel that is normally injected, and this highly ignitable fuel is injected from the injector 15 or a dedicated injector.

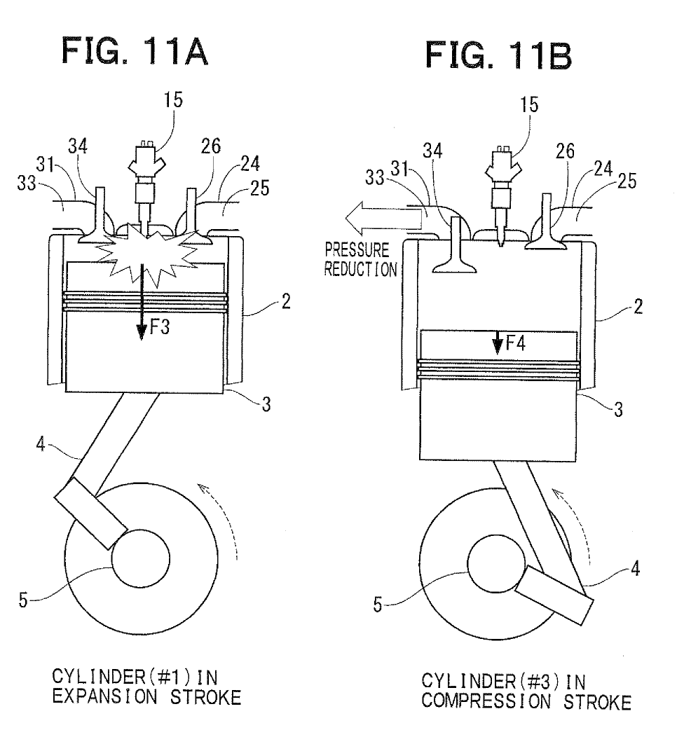

FIG. 11A shows the cylinder, which is stopped in the expansion stroke, and FIG. 11B shows the cylinder, which is stopped in the compression stroke. For example, when the first cylinder is stopped in the expansion stroke, the third cylinder is stopped in the compression stroke. When the fuel is injected into the first cylinder, which is stopped in the expansion stroke, in the operation at step S182, the fuel is self-ignited to resume the expansion stroke. When the expansion stroke of the first cylinder is resumed, a force F3 is applied to the upper end surface of the piston 3 received in the first cylinder. In the present embodiment, the in-cylinder pressure of the third cylinder, which is stopped in the compression stroke, is reduced by the operation executed at step S181. Thereby, a force F4, which urges the piston 3 received in the third cylinder, is reduced. That is, in the first cylinder, in which the expansion stroke is resumed, the force, which limits, i.e., interferes with the movement of the piston 3 of the first cylinder toward the bottom dead center, is reduced. In this way, the piston 3 of the first cylinder can be easily moved toward the bottom dead center. Therefore, the force F3, which is applied to the piston 3 of the first cylinder, can be effectively conducted to the crankshaft 5, so that the engine 11 can be smoothly rotated.

As shown in FIG. 2, the operation proceeds to step S184 after step S182.

At step S183, the ECU 40 operates the starter 12 to rotate the crankshaft 5 of the engine 11. Thereafter, the operation proceeds to step S184.

At step S184, the ECU 40 confirms that the engine 11 is restarted by the operation at step S182 or step S183.

When the operation at step S184 is executed, the main operation is terminated. Thereafter, the main operation shown in FIG. 2 is started once again, so that the operation at step S200 is executed.

As discussed above, the ECU 40 serves as the automatic stop control means at steps S200 S101-S107. Furthermore, the ECU 40 functions as the piston stopping means at steps S102-S107. Also, the ECU 40 functions as the stop aiding means at step S107. In addition, the ECU 40 functions as the restarting means at steps S300, S113, S120, S180-S184. Furthermore, the ECU 40 functions as the compression pressure reducing means at step S181.

As discussed above, the engine starting apparatus of the first embodiment injects the fuel into the cylinder 2, which is stopped in the expansion stroke, when the in-cylinder temperature of the cylinder 2, which is stopped in the expansion stroke, is equal to or higher than the preset temperature upon satisfaction of the restart condition after the stopping of the engine 11 caused by the satisfaction of the engine stop condition. At this time, the in-cylinder temperature of the cylinder 2, in which the fuel is injected, is the temperature, at which the fuel is self-ignitable. Therefore, the fuel, which is injected into the cylinder 2, which is stopped in the expansion stroke, is self-ignited. In this way, the expansion stroke of this cylinder 2 is resumed, and the stopped engine 11 is restarted. In such a case (the case where the in-cylinder temperature of the cylinder 2 stopped in the expansion stroke is equal to or higher than the preset temperature), the engine 11 can be restarted without using the starter 12. Therefore, the increase in the number of uses as well as the operating time period of the starter 12 can be limited. Therefore, the reduction in the lifetime of the starter 12 and the lifetime of the peripheral components thereof can be limited, and the electric power consumption of the starter 12 can be reduced.

In contrast, when the in-cylinder temperature of the cylinder 2, which is stopped in the expansion stroke, is lower than the preset temperature in the state where the restart condition is satisfied after the stop of the engine 11 upon the satisfaction of the engine stop condition, the engine starting apparatus restarts the engine 11 by using the starter 12. That is, in this state of the cylinder 2, the fuel is not self-ignitable. Therefore, the engine starting apparatus restarts the engine 11 by rotating the crankshaft 5 of the engine 11 with the starter 12 rather than injecting the fuel into the cylinder 2 that is stopped in the expansion stroke.

As discussed above, the engine starting apparatus of the present embodiment selects the corresponding means based on the in-cylinder temperature of the engine 11 and restarts the engine 11 through use of this means. Therefore, it is possible to limit the increase in the number of uses of the starter and the operating time period of the starter while the engine 11 is reliably restarted by the corresponding means, which corresponds to the current state.

Furthermore, the engine starting apparatus of the first embodiment includes the piston stopping means for stopping the piston 3 of the cylinder 2, which is in the expansion stroke, in the preset angular range that is located right after the top dead center of the piston 3. In this way, the piston 3 of the cylinder 2, which is in the expansion stroke, is stopped in the preset angular range, which is located right after the top dead center of the piston 3, upon the satisfaction of the engine stop condition. Here, the preset angular range is the top dead center side half of the angular range that extends from the top dead center to the bottom dead center. Therefore, when the fuel is injected in the cylinder 2, which is stopped in the expansion stroke, the in-cylinder pressure generated by the explosion and combustion of the self-ignited fuel can be effectively conducted to the piston 3 and the crankshaft 5. Therefore, at the time of restarting the engine 11, the engine 11 can be smoothly rotated, and the torque of the engine 11 can be increased.

Furthermore, the engine starting apparatus of the first embodiment includes the stop aiding means. When the piston 3 of the cylinder 2, which is in the expansion stroke, needs to be stopped in the preset angular range located right after the top dead center of the piston 3, the stop aiding means aids the stopping of the piston 3 of the cylinder 2, which is in the expansion stroke, by opening the intake valve 26 of the other cylinder 2, which is in the compression stroke, to increase the in-cylinder pressure of the other cylinder 2, which is in the compression stroke. In this way, the pressure is applied to the upper end surface of the piston 3 of the cylinder 2, which is in the compression stroke, so that the piston 3 of this cylinder 2 is urged toward the bottom dead center. Thus, the movement of the piston 3 of the cylinder 2, which is in the expansion stroke, is limited, and is thereby stopped. As a result, when the piston 3 of the cylinder 2, which is in the expansion stroke, needs to be stopped, this piston 3 can be easily and accurately stopped within the preset angular range, which is located right after the top dead center of the piston 3.

The engine starting apparatus of the first embodiment includes the compression pressure reducing means. When the fuel is injected into the cylinder 2, which is stopped in the expansion stroke, upon the satisfaction of the restart condition, the compression pressure reducing means opens the exhaust valve of the cylinder 2, which is stopped in the compression stroke, so that the in-cylinder pressure of the this cylinder 2 is reduced. In this way, the urging force, which is required to urge the piston 3 of the cylinder 2 stopped in the compression stroke toward the bottom dead center, is reduced. Thereby, it is possible to reduce the force, which limits, i.e., interferes with the movement of the piston 3 of the cylinder 2, the expansion stroke of which is restarted, toward the bottom dead center of the piston 3. Therefore, at the time of restarting the engine 11, the engine 11 can be smoothly rotated, and the torque of the engine 11 can be increased.

Furthermore, the engine starting apparatus of the first embodiment injects the highly ignitable fuel at the time of injecting the fuel into the cylinder 2, which is stopped in the expansion stroke, upon satisfaction of the restart condition. Therefore, the fuel, which is injected into the cylinder 2 that is stopped in the expansion stroke, can be easily self-ignited. Therefore, the restart of the engine 11 can be more reliably executed, and the torque of the engine 11 at the time of the engine restart can be increased.

### Second Embodiment

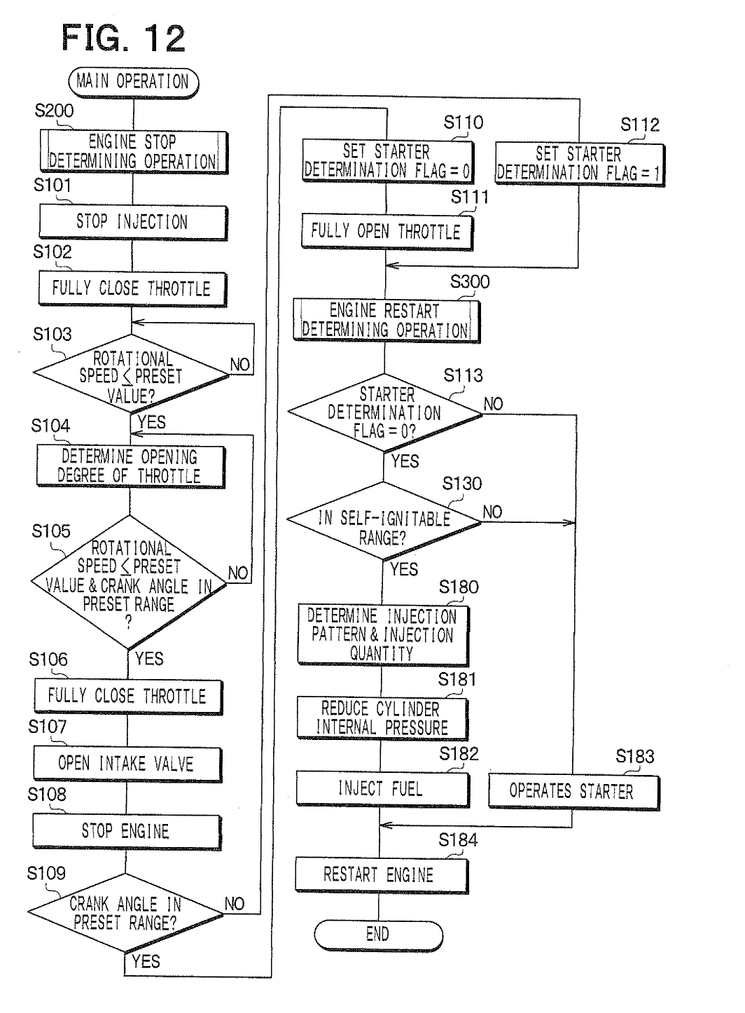

FIG. 12 schematically shows the main operation of the engine starting apparatus according to a second embodiment of the present invention. In the following description, components, which are similar to those of the first embodiment, will be indicated by the same reference numerals and will not be described further.

The engine starting apparatus of the second embodiment is applied to the engine system 10 of FIG. 1 like in the case of the engine starting apparatus of the first embodiment. As shown in FIG. 12, the main operation of the engine starting apparatus of the second embodiment is substantially the same as the main operation of the engine starting apparatus of the first embodiment except the following point. That is, when it is determined that the value of the starter determination flag is 0 at step S113 (i.e., YES at step S113), the operation proceeds to step S130 instead of step S120 of FIG. 2. Hereinafter, the operation of the ECU 40, which serves as the engine starting apparatus, at step S130 will be described.

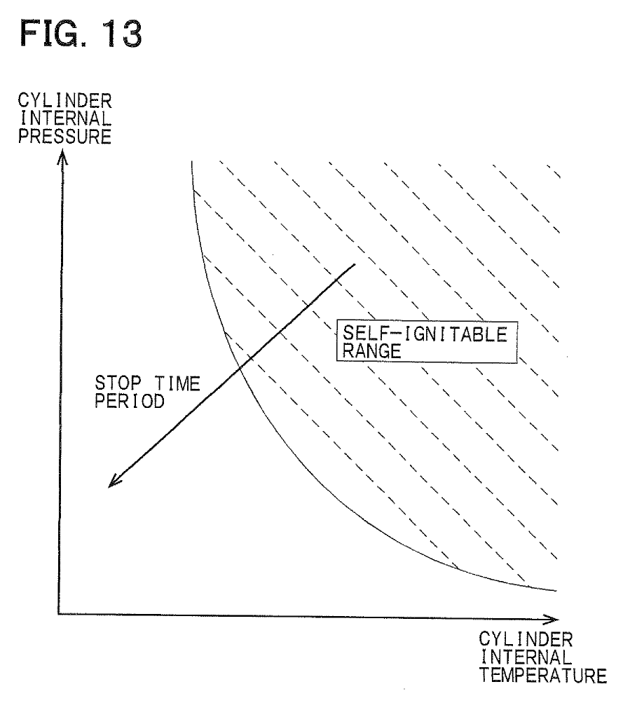

At step S130, the ECU 40 determines whether a relationship between the in-cylinder temperature and the in-cylinder pressure of the cylinder 2, which is stopped in the expansion stroke, satisfies a preset condition based on the crank angle information, which is stored at the time of the engine stop, the measurement signals from the in-cylinder temperature sensor 46 and the in-cylinder pressure sensor 47 provided in to the cylinder 2. As shown in FIG. 13, when the engine 11 is stopped, the in-cylinder temperature and the in-cylinder pressure of the cylinder 2 of the engine 11 shift toward the outside of the self-ignitable range of the fuel with time. The preset condition may be that “the in-cylinder temperature and the in-cylinder pressure are in the self-ignitable range”. When it is determined that the relationship between the in-cylinder temperature and the in-cylinder pressure of the cylinder 2, which is stopped in the expansion stroke, satisfies the preset condition at step S130 (i.e., YES at step S130), the operation proceeds to step S180. When it is determined that the relationship between the in-cylinder temperature and the in-cylinder pressure of the cylinder 2 stopped in the expansion stroke does not satisfy the preset condition at step S130 (i.e., NO at step S130), the operation proceeds to step S183.

As discussed above, the engine starting apparatus of the second embodiment injects the fuel into the cylinder 2, which is stopped in the expansion stroke, when the relationship between the in-cylinder temperature and the in-cylinder pressure of the cylinder 2, which is stopped in the expansion stroke, satisfies the preset condition upon satisfaction of the restart condition after the stopping of the engine 11 caused by the satisfaction of the engine stop condition. At this time, the in-cylinder temperature and the in-cylinder pressure of the cylinder 2, into which the fuel is injected, are in the self-ignitable condition. Therefore, the fuel, which is injected into the cylinder 2 that is stopped in the expansion stroke, is self-ignited. In this way, the expansion stroke of this cylinder 2 is resumed, and the stopped engine 11 is restarted. In such a case (the case where the relationship between the in-cylinder temperature and the in-cylinder pressure of the cylinder 2 stopped in the expansion stroke satisfies the preset condition), the engine 11 can be restarted without using the starter 12. Therefore, the increase in the number of uses as well as the operating time period of the starter 12 can be limited. Therefore, the reduction in the lifetime of the starter 12 and the lifetime of the peripheral components thereof can be limited, and the electric power consumption of the starter 12 can be reduced.

In contrast, when the relationship between the in-cylinder temperature and the in-cylinder pressure of the cylinder 2, which is stopped in the expansion stroke, does not satisfy the preset condition, in the state where the restart condition is satisfied after the stop of the engine 11 upon the satisfaction of the engine stop condition, the engine starting apparatus restarts the engine 11 by using the starter 12. That is, in this state of the cylinder 2, the fuel is not self-ignitable. Therefore, similar to the first embodiment, the engine starting apparatus restarts the engine 11 by rotating the crankshaft 5 of the engine 11 with the starter 12 rather than injecting the fuel into the cylinder 2 that is stopped in the expansion stroke.

As discussed above, the engine starting apparatus of the present embodiment selects the corresponding means based on the relationship between the in-cylinder temperature and the in-cylinder pressure of the engine 11 and restarts the engine 11 through use of this means. Therefore, it is possible to limit the increase in the number of uses of the starter and the operating time period of the starter while the engine 11 is reliably restarted by the corresponding means, which corresponds to the current state.

### Third Embodiment

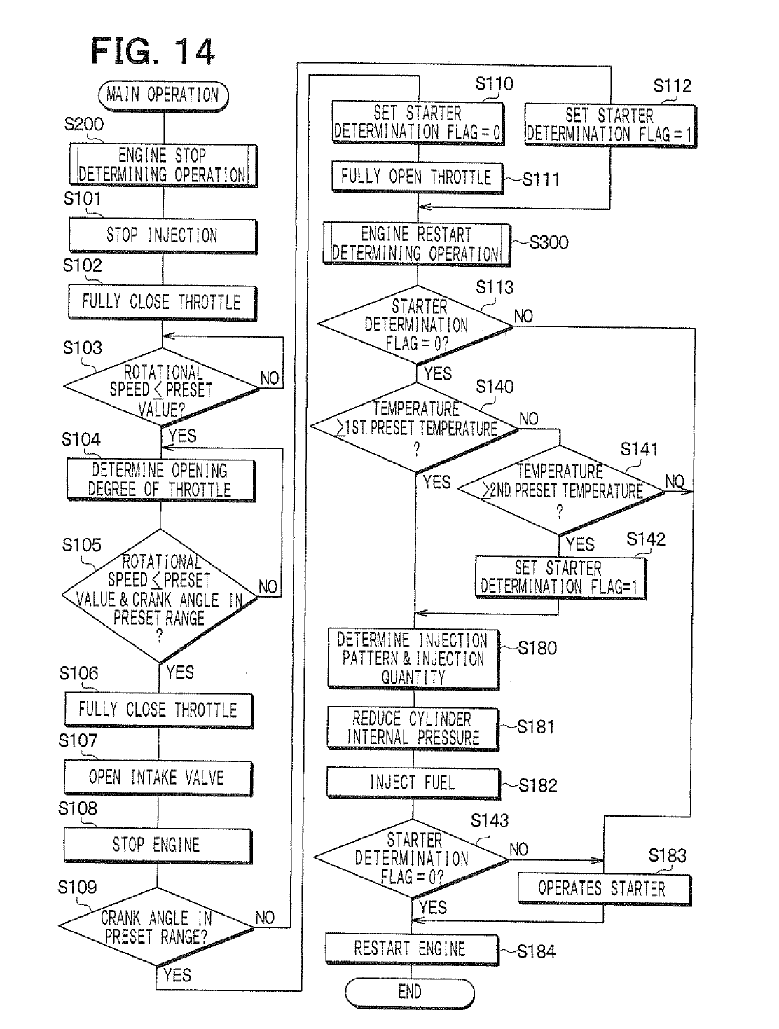

FIG. 14 schematically shows the main operation of the engine starting apparatus according to a third embodiment of the present invention. In the following description, components, which are similar to those of the first embodiment, will be indicated by the same reference numerals and will not be described further.

The engine starting apparatus of the third embodiment is applied to the engine system 10 of FIG. 1 like in the case of the engine starting apparatus of the first embodiment. As shown in FIG. 14, the main operation of the engine starting apparatus of the third embodiment is substantially the same as the main operation of the engine starting apparatus of the first embodiment except the operation at and after step S113.

In the main operation of the engine starting apparatus of the third embodiment, when it is determined that the value of the starter determination flag is 0 at step S113 (i.e., YES at step S113), the operation proceeds to step S140. In contrast, when it is determined that the value of the starter determination flag is not 0, i.e., the value of the starter determination flag is 1 at step S113 (i.e., NO at step S113), the operation proceeds to step S183.

At step S140, the ECU 40 determines whether the in-cylinder temperature of the cylinder 2, which is in the expansion stroke, is equal to or higher than a first preset temperature based on the crank angle information, which is stored in the stop period of the engine 11, and the measurement signal of the in-cylinder temperature sensor 46 provided to the cylinder 2. The first preset temperature is set to be the temperature within the self-ignitable temperature range of the fuel. When it is determined that the in-cylinder temperature of the cylinder 2, which is stopped in the expansion stroke, is equal to or higher than the first preset temperature at step S140 (i.e., YES at step S140), the operation proceeds to step S180. When it is determined that the in-cylinder temperature of the cylinder 2, which is stopped in the expansion stroke, is lower than the first preset temperature at step S140 (i.e., NO at step S140), the operation proceeds to step S141.

At step S141, the ECU 40 determines whether the in-cylinder temperature of the cylinder 2, which is stopped in the expansion stroke, is equal to or higher than a second preset temperature based on the crank angle information, which is stored in the stop period of the engine 11, and the measurement signal of the in-cylinder temperature sensor 46 provided to the cylinder 2. The second preset temperature is set to be the self-ignitable lower limit temperature of the fuel. That is, the second preset temperature is lower than the first preset temperature. When it is determined that the in-cylinder temperature of the cylinder 2, which is stopped in the expansion stroke, is equal to or higher than the second preset temperature at step S141 (i.e., YES at step S141), the operation proceeds to step S142. When it is determined that the in-cylinder temperature of the cylinder 2, which is stopped in the expansion stroke, is lower than the second preset temperature at step S141 (i.e., NO at step S141), the operation proceeds to step S183.

At step S142, the ECU 40 stores 1 as the value of the starter determination flag in the RAM. Thereafter, the operation proceeds to step S180.

In the present embodiment, step S143 is executed after the execution of steps S180-S182.

At step S143, the ECU 40 determines whether the value of the starter determination flag stored in the RAM is 0. When it is determined that the value of the starter determination flag is 0 at step S143 (i.e., YES at step S143), the operation proceeds to step S184. In contrast, when it is determined that the value of the starter determination flag is not 0, i.e., the value of the starter determination flag is 1 at step S143 (i.e., NO at step S143), the operation proceeds to step S183.

In the case of the engine starting apparatus of the present embodiment, the ECU 40 restarts the engine 11 by injecting the fuel into the cylinder 2, which is stopped in the expansion stroke, through the execution of steps S180-S182 when the in-cylinder temperature of the cylinder 2, which is stopped in the expansion stroke, is equal to or higher than the first preset temperature (i.e., YES at step S140) upon the stopping of the crank angle within the preset angular range (i.e., YES at step S109, and the starter determination flag=0).

Furthermore, the ECU 40 restarts the engine 11 by rotating the crankshaft 5 of the engine 11 with the starter 12 through execution of step S183 and also by injecting the fuel into the cylinder 2, which is stopped in the expansion stroke, by executing steps S180-S182 when the in-cylinder temperature of the cylinder 2, which is stopped in the expansion stroke, is lower than the first preset temperature and is equal to or higher than the second preset temperature (i.e., NO at step S140, YES at step S141, the starter determination flag=1) upon the stopping of the crank angle within the preset angular range (i.e., YES at step S109, and the starter determination flag=0).

Furthermore, the ECU 40 restarts the engine 11 by rotating the crankshaft 5 of the engine 11 with the starter 12 through execution of step S183 without executing steps S180-S182 when the temperature of the cylinder 2, which is stopped in the expansion stroke, is lower than the first preset temperature and the second preset temperature (i.e., NO at step S140, NO at step S141) upon stopping of the crank angle out of the preset angular range (i.e., NO at step S109, the starter determination flag=1) or upon stopping of the crank angle within the preset angular range (i.e., YES at step S109, the starter determination flag=0).

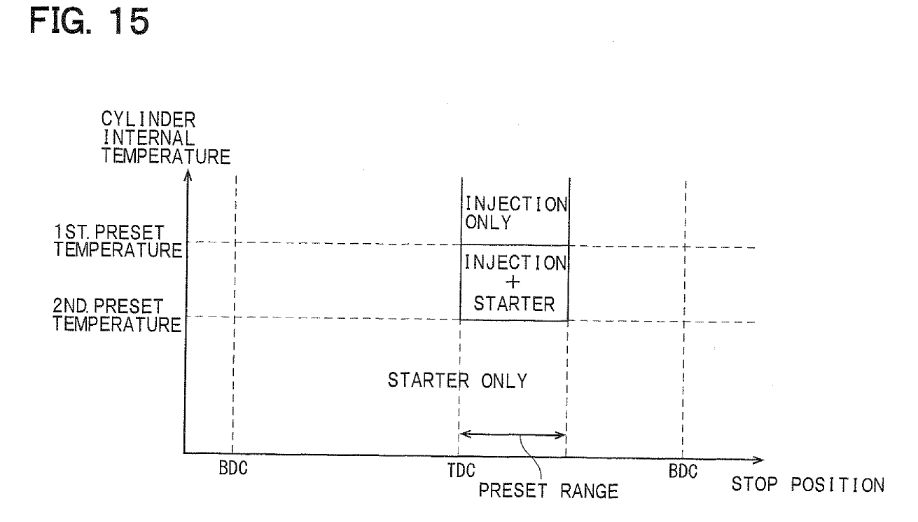

As discussed above, the engine starting apparatus of the present embodiment restarts the engine 11 only with the starter 12 when the crank angle is held outside of the preset angular range in the stopped state of the engine 11. In contrast, with reference to FIG. 15, in the case where the crank angle is held within the preset angular range in the stop state of the engine 11, when the in-cylinder temperature of the cylinder 2, which is stopped in the expansion stroke, is equal to or higher than the first preset temperature, the engine starting apparatus restarts the engine 11 only by injecting the fuel into the cylinder 2, which is stopped in the expansion stroke. Furthermore, in the same case where the crank angle is held within the preset angular range in the stop state of the engine 11, when the temperature of the cylinder 2, which is stopped in the expansion stroke, is lower than the first preset temperature and is equal to or higher than the second preset temperature, the engine starting apparatus restarts the engine 11 by rotating the crankshaft 5 of the engine 11 with the starter 12 and also by injecting the fuel into the cylinder 2, which is stopped in the expansion stroke. Also, in the same case where the crank angle is held within the preset angular range in the stop state of the engine 11, when the temperature of the cylinder 2, which is stopped in the expansion stroke, is lower than the first preset temperature and the second preset temperature, the engine starting apparatus restarts the engine 11 only by rotating the crankshaft 5 of the engine 11 with the starter 12. That is, the engine starting apparatus of the present embodiment selects the means for restarting the engine 11 based on the state (the in-cylinder temperature) of the cylinder 2 of the engine 11.

As discussed above, the engine starting apparatus of the third embodiment injects the fuel into the cylinder 2, which is stopped in the expansion stroke, when the in-cylinder temperature of the cylinder 2, which is stopped in the expansion stroke, is equal to or higher than the first preset temperature upon satisfaction of the restart condition after the stopping of the engine 11 caused by the satisfaction of the engine stop condition. At this time, the in-cylinder temperature of the cylinder 2, in which the fuel is injected, is the temperature, at which the fuel is self-ignitable. Therefore, the fuel, which is injected into the cylinder 2, which is stopped in the expansion stroke, is self-ignited. In this way, the expansion stroke of this cylinder 2 is resumed, and the stopped engine 11 is restarted In such a case (the case where the in-cylinder temperature of the cylinder 2 stopped in the expansion stroke is equal to or higher than the first preset temperature), the engine 11 can be restarted without using the starter 12. Therefore, the increase in the number of uses as well as the operating time period of the starter 12 can be limited. Therefore, the reduction in the lifetime of the starter 12 and the lifetime of the peripheral components thereof can be limited, and the electric power consumption of the starter 12 can be reduced.

Furthermore, in the present embodiment, when the in-cylinder temperature of the cylinder 2, which is stopped in the expansion stroke, is lower than the first preset temperature and is equal to or higher than the second preset temperature upon satisfaction of the restart condition after the stopping of the engine 11 caused by the satisfaction of the engine stop condition, the engine 11 is restarted by injecting the fuel into the cylinder 2, which is stopped in the expansion stroke, and by rotating the crankshaft 5 of the engine 11 with the starter 12. At this time, the temperature of the cylinder 2, into which the fuel is injected, is the self-ignitable temperature of the fuel. Therefore, the fuel, which is injected into the cylinder 2, is self-ignited, and thereby the expansion stroke of the cylinder 2 is resumed. At this time, the in-cylinder temperature of the cylinder 2 may possibly be the temperature at or around the self-ignitable lower limit temperature of the fuel. In such a case, even when the fuel is self-ignited in the cylinder, the rotational force of the engine 11 may possibly be small. However, in the present embodiment, at this time, besides injecting the fuel into the cylinder 2, which is stopped in the expansion stroke, the crankshaft 5 of the engine 11 is rotated with the starter 12. Therefore, it is possible to obtain the rotational force by the combustion of the fuel from the beginning of the rotation of the crankshaft 5. In this way, the engine restart time period can be reduced, and thereby the increase in the starter operating time period is limited. Therefore, the reduction in the lifetime of the starter and the lifetime of the peripheral components thereof can be limited, and the electric power consumption of the starter can be reduced.

Furthermore, according to the present embodiment, when the in-cylinder temperature of the cylinder 2, which is stopped in the expansion stroke, is lower than the second preset temperature in the state where the restart condition is satisfied after the stop of the engine 11 upon the satisfaction of the engine stop condition, the engine 11 is restarted by using the starter 12. That is, in this state of the cylinder 2, the fuel is not self-ignitable. Therefore, similar to the first embodiment, the engine starting apparatus restarts the engine 11 by rotating the crankshaft 5 of the engine 11 with the starter 12 rather than injecting the fuel into the cylinder 2 that is stopped in the expansion stroke.

As discussed above, the engine starting apparatus of the present embodiment selects the corresponding means based on the in-cylinder temperature of the cylinder 2 of the engine 11 and restarts the engine 11 through use of this means. Therefore, it is possible to limit the increase in the number of uses of the starter and the operating time period of the starter while the engine 11 is reliably restarted by the corresponding means, which corresponds to the current state.

Now, modifications of the above embodiments will be described.

As a modification of the above embodiments, the ECU may function as the stop aiding means, and each cylinder may be provided with, for example, a supply device, which can supply the high pressure air into the cylinder without requiring the introduction of the supercharging pressure by opening the intake valve at the time of increasing the in-cylinder pressure, which is in the compression stroke. In this way, the in-cylinder pressure, which is in the compression stroke, can be increased.

Furthermore, the in-cylinder temperature may be estimated based on, for example, the measurement signal of the coolant temperature sensor, which is provided to the radiator, without relying on the measurement signal of the temperature sensor provided to each cylinder.

Also, the injection pattern of the fuel, which is determined based on the in-cylinder temperature, may not need to be selected from the three patterns of the above embodiment and may be selected from any number of patterns. Alternatively, the injection pattern, which is determined based on the in-cylinder temperature, may be fixed to a single pattern.

Also, in the case where the ECU functions as the compression pressure reducing means to reduce the compression pressure of the cylinder, which is stopped in the compression stroke, the compression pressure of the cylinder may be reduced by discharging the air from the cylinder by opening another valve, which is other than the exhaust valve, instead of discharging the air from the cylinder by opening the exhaust valve.

Furthermore, when the fuel is injected into the cylinder, which is stopped in the expansion stroke, after satisfaction of the restart condition, the normal fuel may be injected instead of the highly ignitable fuel.

Also, the ECU may perform an operation that reduces the load, which is applied against the rotation of the engine, at step S182 or step S183 at the time of restarting the engine. This operation may be performed by, for example, stopping an operation of an air conditioning system, which may possibly apply the load against the rotation of the engine, or decoupling a clutch, which may possibly apply the load against the rotation of the engine, or stopping the supply of the fuel to the supply pump, which requires the rotational force of the engine. As discussed above, the engine can be more reliably restarted by reducing the load against the rotation of the engine at the time of restarting the engine.

Furthermore, as another modification of the above embodiments, the main operation at step S109 and the following steps may be executed when the engine is stopped by another reason, which is other than the stop of the engine by the automatic stop control means, such as the unexpected stop of the engine. In this way, even when the engine is stopped by the other reason other than the stop by the automatic stop control means, the engine may be restarted without using the starter depending on the crank angle at the time of the engine stop and the state of the cylinder of the engine.

As discussed above, the present invention is not limited to the above embodiment, and the above embodiment may be modified within the spirit and scope of the present invention.

Additional advantages and modifications will readily occur to those skilled in the art. The invention in its broader terms is therefore not limited to the specific details, representative apparatus, and illustrative examples shown and described.

What is claimed is:

1. An engine starting apparatus for a diesel engine, comprising:
a fuel injection means for injecting fuel from a plurality of fuel injection valves, which are respectively provided to a plurality of cylinders of the diesel engine, into the plurality of cylinders, respectively;
a starter that is adapted to start the diesel engine by rotating a crankshaft of the diesel engine;
an automatic stop control means for automatically stopping the diesel engine when an engine stop condition, which is a condition required for engine stop, is satisfied; and
a restarting means for restarting the diesel engine upon satisfaction of a restart condition, which is a condition required for engine start, after stopping of the diesel engine caused by satisfaction of at least the engine stop condition as follows:
the restarting means restarts the diesel engine without using the starter by injecting fuel into one of the plurality of cylinders, which is stopped in an expansion stroke, through the fuel injection means when an in-cylinder temperature of the one of the plurality of cylinders, which is stopped in the expansion stroke, is equal to or higher than a preset temperature; and
the restarting means restarts the diesel engine by using the starter when the in-cylinder temperature of the one of the plurality of cylinders, which is stopped in the expansion stroke, is lower than the preset temperature.

2. The engine starting apparatus according to claim 1, wherein the automatic stop control means includes a piston stopping means for stopping a piston at one of the plurality of cylinders, which is in an expansion stroke, within a preset angular range located right after a top dead center of the piston upon the satisfaction of the engine stop condition.

3. The engine starting apparatus according to claim 2, wherein the piston stopping means includes a stop aiding means for aiding the stopping of the piston at the one of the plurality of cylinders, which is in the expansion stroke, by increasing an in-cylinder pressure of one of the plurality of cylinders, which is in a compression stroke.

4. The engine starting apparatus according to claim 3, wherein the stop aiding means increases the in-cylinder pressure of the one of the plurality of cylinders, which is in the compression stroke, by opening an intake valve of the one of the plurality of cylinders, which is in the compression stroke, to introduce a supercharging pressure into the one of the plurality of cylinders, which is in the compression stroke.

5. The engine starting apparatus according to claim 1, wherein the restarting means includes a compression pressure reducing means for reducing an in-cylinder pressure of one of the plurality of cylinders, which is stopped in a compression stroke.

6. The engine starting apparatus according to claim 5, wherein the compression pressure reducing means reduces the in-cylinder pressure of the one of the plurality of cylinders, which is stopped in the compression stroke, by opening an exhaust valve of the one of the plurality of cylinders, which is stopped in the compression stroke.

7. The engine starting apparatus according to claim 1, wherein the restarting means injects fuel having high ignitability when the restarting means injects the fuel into the one of the plurality of cylinders, which is stopped in the expansion stroke, through the fuel injection means.

8. An engine starting apparatus for a diesel engine, comprising:
a fuel injection means for injecting fuel from a plurality of fuel injection valves, which are respectively provided to a plurality of cylinders of the diesel engine, into the plurality of cylinders, respectively;
a starter that is adapted to start the diesel engine by rotating a crankshaft of the diesel engine;
an automatic stop control means for automatically stopping the diesel engine when an engine stop condition, which is a condition required for engine stop, is satisfied; and
a restarting means for restarting the diesel engine upon satisfaction of a restart condition, which is a condition required for engine start, after stopping of the diesel engine caused by satisfaction of at least the engine stop condition as follows:
the restarting means restarts the diesel engine without using the starter by injecting fuel into one of the plurality of cylinders, which is stopped in an expansion stroke, through the fuel injection means when a relationship between an in-cylinder temperature and an in-cylinder pressure of the one of the plurality of cylinders, which is stopped in the expansion stroke, satisfies a preset condition; and
the restarting means restarts the diesel engine by using the starter when the relationship between the in-cylinder temperature and the in-cylinder pressure of the one of the plurality of cylinders, which is stopped in the expansion stroke, does not satisfy the preset condition.

9. The engine starting apparatus according to claim 8, wherein the automatic stop control means includes a piston stopping means for stopping a piston at one of the plurality of cylinders, which is in an expansion stroke, within a preset angular range located right after a top dead center of the piston upon the satisfaction of the engine stop condition.

10. The engine starting apparatus according to claim 9, wherein the piston stopping means includes a stop aiding means for aiding the stopping of the piston at the one of the plurality of cylinders, which is in the expansion stroke, by increasing an in-cylinder pressure of one of the plurality of cylinders, which is in a compression stroke.

11. The engine starting apparatus according to claim 10, wherein the stop aiding means increases the in-cylinder pressure of the one of the plurality of cylinders, which is in the compression stroke, by opening an intake valve of the one of the plurality of cylinders, which is in the compression stroke, to introduce a supercharging pressure into the one of the plurality of cylinders, which is in the compression stroke.

12. The engine starting apparatus according to claim 8, wherein the restarting means includes a compression pressure reducing means for reducing an in-cylinder pressure of one of the plurality of cylinders, which is stopped in a compression stroke.

13. The engine starting apparatus according to claim 12, wherein the compression pressure reducing means reduces the in-cylinder pressure of the one of the plurality of cylinders, which is stopped in the compression stroke, by opening an exhaust valve of the one of the plurality of cylinders, which is stopped in the compression stroke.

14. The engine starting apparatus according to claim 8, wherein the restarting means injects fuel having high ignitability when the restarting means injects the fuel into the one of the plurality of cylinders, which is stopped in the expansion stroke, through the fuel injection means.

15. An engine starting apparatus for a diesel engine, comprising:
a fuel injection means for injecting fuel from a plurality of fuel injection valves, which are respectively provided to a plurality of cylinders of the diesel engine, into the plurality of cylinders, respectively;
a starter that is adapted to start the diesel engine by rotating a crankshaft of the diesel engine;
an automatic stop control means for automatically stopping the diesel engine when an engine stop condition, which is a condition required for engine stop, is satisfied; and
a restarting means for restarting the diesel engine upon satisfaction of a restart condition, which is a condition required for engine start, after stopping of the diesel engine caused by satisfaction of at least the engine stop condition as follows:
the restarting means restarts the diesel engine without using the starter by injecting fuel into one of the plurality of cylinders, which is stopped in an expansion stroke, through the fuel injection means when an in-cylinder temperature of the one of the plurality of cylinders, which is stopped in the expansion stroke, is equal to or higher than a first preset temperature;
the restarting means restarts the diesel engine by using the starter and also by injecting fuel into the one of the plurality of cylinders, which is stopped in the expansion stroke, through the fuel injection means when the in-cylinder temperature of the one of the plurality of cylinders, which is stopped in the expansion stroke, is lower than the first preset temperature and is equal to or higher than a second preset temperature that is lower than the first preset temperature; and
the restarting means restarts the diesel engine by using the starter when the in-cylinder temperature of the one of the plurality of cylinders, which is stopped in the expansion stroke, is lower than the second preset temperature.

16. The engine starting apparatus according to claim 15, wherein the automatic stop control means includes a piston stopping means for stopping a piston at one of the plurality of cylinders, which is in an expansion stroke, within a preset angular range located right after a top dead center of the piston upon the satisfaction of the engine stop condition.

17. The engine starting apparatus according to claim 16, wherein the piston stopping means includes a stop aiding means for aiding the stopping of the piston at the one of the plurality of cylinders, which is in the expansion stroke, by increasing an in-cylinder pressure of one of the plurality of cylinders, which is in a compression stroke.

18. The engine starting apparatus according to claim 17, wherein the stop aiding means increases the in-cylinder pressure of the one of the plurality of cylinders, which is in the compression stroke, by opening an intake valve of the one of the plurality of cylinders, which is in the compression stroke, to introduce a supercharging pressure into the one of the plurality of cylinders, which is in the compression stroke.

19. The engine starting apparatus according to claim 15, wherein the restarting means includes a compression pressure reducing means for reducing an in-cylinder pressure of one of the plurality of cylinders, which is stopped in a compression stroke.

20. The engine starting apparatus according to claim 19, wherein the compression pressure reducing means reduces the in-cylinder pressure of the one of the plurality of cylinders, which is stopped in the compression stroke, by opening an exhaust valve of the one of the plurality of cylinders, which is stopped in the compression stroke.

21. The engine starting apparatus according to claim 15, wherein the restarting means injects fuel having high ignitability when the restarting means injects the fuel into the one of the plurality of cylinders, which is stopped in the expansion stroke, through the fuel injection means.
